(19) United States
(12) Patent Application Publication
(10) Pub. No.: US 2019/0055458 A1
(43) Pub. Date: Feb. 21, 2019

(54) COMPOSITIONS COMPRISING AROMATIC ESTER SOLVENTS FOR USE IN OIL AND/OR GAS WELLS AND RELATED METHODS

(71) Applicant: Flotek Chemistry, LLC, Houston, TX (US)

(72) Inventors: Richard Harlen Smith, JR., Spring, TX (US); Randal M. Hill, The Woodlands, TX (US)

(73) Assignee: Flotek Chemistry, LLC, Houston, TX (US)

(21) Appl. No.: 15/680,460

(22) Filed: Aug. 18, 2017

(51) Int. Cl. C09K 8/524

(52) U.S. Cl. CPC C09K 8/524

(57) ABSTRACT

Compositions comprising aromatic ester solvents for use in various aspects of a life cycle of an oil and/or gas well, and related methods, are provided. In some embodiments, the composition includes an emulsion or microemulsion wherein the emulsion or microemulsion comprises an aqueous phase, a surfactant, and a non-aqueous phase. In some embodiments, the non-aqueous phase comprises a solvent blend including a first type of solvent and a second type of solvent, e.g., having a respective weight ratio of about 3:2 to 1:4. In some embodiments, the first type of solvent is a terpene and/or the second type of solvent is an aromatic ester solvent. In some embodiments, compositions are used in methods for treating an oil and/or gas well having a wellbore. In some embodiments, the composition is delivered into the wellbore, reducing residues comprising kerogens, asphaltenes, paraffins, organic scale, or combinations thereof on or near the wellbore.

### FIELD OF INVENTION

Compositions comprising aromatic ester solvents for use in various aspects of the life cycle of an oil and/or gas well, and related methods, are provided.

### BACKGROUND OF INVENTION

Emulsions and/or microemulsions are commonly employed in a variety of operations related to the extraction of hydrocarbons, such as well stimulation.

Subterranean formations are often stimulated to improve recovery of hydrocarbons. Common stimulation techniques include hydraulic fracturing. Hydraulic fracturing consists of the high pressure injection of a fluid containing suspended proppant into the wellbore in order to create fractures in the rock formation and facilitate production from low permeability zones. All chemicals pumped downhole in an oil and/or gas well can filter through the reservoir rock and block pore throats with the possibility of creating formation damage. It is well known that fluid invasion can significantly reduce hydrocarbon production from a well. In order to reduce fluid invasion, emulsions or microemulsions are generally added to the well-treatment fluids to help unload the residual aqueous treatment from the formation.

Accordingly, although a number of emulsions or microemulsions are known in the art, there is a continued need for more effective emulsions or microemulsions for use in treatment of an oil and/or gas well.

### SUMMARY OF INVENTION

Generally, compositions comprising aromatic ester solvents for use in various aspects of the life cycle of an oil and/or gas well, and related methods, are provided.

In one aspect, this disclosure is generally directed toward a composition. In some embodiments, the composition may be used for treating an oil and/or gas well having a wellbore. In some embodiments, the composition comprises a microemulsion, wherein the microemulsion comprises an aqueous phase; a surfactant; and a solvent blend, comprising a first type of solvent and a second type of solvent, having a weight ratio from about 3:2 to about 1:4, wherein the first type of solvent is a terpene and the second type of solvent is an aromatic ester solvent.

In another aspect, this disclosure is generally directed toward a method. In some embodiments, the method is a method of treating an oil and/or gas well having a wellbore. In some embodiments, the method comprises delivering a composition into the wellbore, wherein the composition comprises a microemulsion, wherein the microemulsion comprises an aqueous phase; a surfactant; and a solvent blend, comprising a first type of solvent and a second type of solvent, having a weight ratio from about 3:2 to about 1:4, wherein the first type of solvent is a terpene and the second type of solvent is an aromatic ester solvent; and reducing residues on or near the wellbore using the composition.

Other aspects, embodiments, and features of the methods and compositions will become apparent from the following detailed description when considered in conjunction with the accompanying drawings. All patent applications and patents incorporated herein by reference are incorporated by reference in their entirety. In case of conflict, the present specification, including definitions, will control.

### BRIEF DESCRIPTION OF THE DRAWINGS

The accompanying drawings are not intended to be drawn to scale. For purposes of clarity, not every component may be labeled in every drawing. In the drawings:

FIG. 1 shows an exemplary schematic diagram showing asphaltene deposition on pillar surfaces of a microfluidic device for testing the efficacy of microemulsions comprising aromatic ester solvents, according to some embodiments;

FIG. 2A shows an exemplary microscope image of asphaltene deposition in a microfluidic device before treatment with a microemulsion comprising d-limonene and benzyl benzoate, according to some embodiments;

FIG. 2B shows an exemplary microscope image of asphaltene wash-off in a microfluidic device after treatment with a microemulsion comprising d-limonene and benzyl benzoate, according to some embodiments;

FIG. 3 shows an exemplary plot comparing asphaltene wash-off at a visual softening time of asphaltene for formulations comprising microemulsions comprising a solvent blend comprising different weight ratios of d-limonene to benzyl benzoate, according to some embodiments; and

FIG. 4 shows an exemplary plot comparing asphaltene wash-off at 13.5 minutes for formulations comprising microemulsions comprising a solvent blend comprising different weight ratios of d-limonene to benzyl benzoate, according to some embodiments.

### DETAILED DESCRIPTION

Compositions comprising aromatic ester solvents for use in various aspects of the life cycle of an oil and/or gas well, and related methods, are provided. In some embodiments, the composition is provided as an emulsion or a microemulsion, wherein the emulsion or microemulsion comprises an aqueous phase, a surfactant, and a non-aqueous phase. In some embodiments, the non-aqueous phase comprises a solvent blend. The solvent blend may comprise a first type of solvent and a second type of solvent. In some embodiments, the first type of solvent and the second type of solvent may be provided in a ratio from about 3:2 to about 1:4 by weight of the first type of solvent to the second type of solvent. In some embodiments, the first type of solvent is a terpene. In some embodiments, the second type of solvent is an aromatic ester solvent. In some embodiments, the compositions are used in methods relating to treating an oil and/or gas well having a wellbore. In some embodiments, an emulsion or microemulsion is delivered into the wellbore, reducing residues comprising kerogens, asphaltenes, paraffins, organic scale, or combinations thereof on or near the wellbore.

During the process of producing oil from an oil well, it is possible for the wellbore or near-wellbore area to become plugged due to the deposition of various residues such as paraffins or asphaltenes. As these residues build up, production of oil decreases. In extreme cases, this can cause production to cease altogether.

There are a variety of ways to remove residues and deposits from the wellbore and near-wellbore area. These include hot oiling, chemical treatments, solvent treatment, and other techniques, each with advantages and deficiencies. The invention described below provides unique advantages for removing residues and deposits from the wellbore and near-wellbore area. The invention comprises a microemulsion which can be diluted before it is used, allowing treatment with a reduced amount of chemicals. Even when highly diluted with water, the invention demonstrates asphaltenes removal comparable to that of neat solvents.

Additional details regarding the emulsions or microemulsions, as well as the applications of the emulsions or microemulsions, are described herein. The terms emulsions and microemulsions should be understood to include emulsions or microemulsions that have a water continuous phase, or that have an oil continuous phase, or microemulsions that are bicontinuous or multiple continuous phases of water and oil. In some embodiments, the emulsion or microemulsion has a water continuous phase. Additional details regarding emulsions and microemulsions and components therein are described herein.

The emulsion or microemulsion generally comprises a non-aqueous phase. In some embodiments, the non-aqueous phase comprises a solvent blend, comprising at least two types of solvents. For example, the solvent blend may comprise a first type of solvent and a second type of solvent. In some embodiments, the emulsion or microemulsion comprises from about 1 wt % to about 30 wt %, or from about 2 wt % to about 25 wt %, or from about 5 wt % to about 25 wt %, or from about 15 wt % to about 25 wt %, or from about 3 wt % to about 40 wt %, or from about 5 wt % to about 30 wt %, or from about 7 wt % to about 22 wt % of the total amount of the solvent blend, versus the total weight of the emulsion or microemulsion composition. In some embodiments, the first type of solvent is a terpene and/or the second type of solvent is an aromatic ester solvent. In some embodiments, a solvent is a liquid that dissolves other substances, for example, residues or other substances found at or in a wellbore (e.g. kerogens, asphaltenes, paraffins, organic scale).

In some embodiments, the first type of solvent (e.g., a terpene) and the second type of solvent (e.g., an aromatic ester solvent) in the non-aqueous solvent blend are provided in a ratio from about 3:2 to about 3:7, or from 3:2 to about 1:4, by weight of the first type of solvent to the second type of solvent. In some embodiments, the ratio is from about 9:11 to 7:13, or about 2:3.

In some embodiments, each solvent type may comprise more than one solvent of that type. For example, the first type of solvent may include a single terpene and the second type of solvent may include a single aromatic ester solvent. As another non-limiting example, the first type of solvent may include a first terpene and a second, different terpene, and/or the second type of solvent may include a first aromatic ester solvent and a second, different aromatic ester solvent.

In some embodiments, the first type of solvent in the solvent blend in the composition is a substance with a significant hydrophobic character with linear, branched, cyclic, bicyclic, saturated or unsaturated structure. Examples of categories of the first type of solvent include but are not limited to terpenes, terpineols, terpene alcohols, aldehydes, ketones, esters, amines, and amides. In some embodiments, the solvent blend may comprise a terpene. In some embodiments, the solvent blend may comprise an aliphatic hydrocarbon liquid. In some embodiments, the solvent blend may comprise a water-immiscible hydrocarbon liquid. In some embodiments, the first type of solvent in a non-aqueous solvent blend in the composition is a substance (e.g., a liquid) with a significant hydrophobic character with linear, branched, cyclic, bicyclic, saturated, or unsaturated structure, including terpenes and/or alkyl aliphatic carboxylic acid esters.

Examples of categories of solvent in the solvent blend include but are not limited to terpenes, terpineols, terpene alcohols, aldehydes, ketones, esters, amines, amides, terpenoids, alkyl aliphatic carboxylic acid esters, aliphatic hydrocarbon liquids, water immiscible hydrocarbon liquids, silicone fluids and combinations thereof. Additional details are provided herein.

In some embodiments, the second type of solvent comprises at least one aromatic ester solvent. In some embodiments, the second type of solvent is an aromatic ester solvent. As noted above, the at least one type of solvent may comprise more than one aromatic ester solvent, e.g., a first aromatic ester solvent and a second, different, aromatic ester solvent. For example, in some embodiments, the second type of solvent comprises a first aromatic ester solvent and a second aromatic ester solvent. As used herein, the term “aromatic ester” is given its ordinary meaning in the art and refers to an ester in which the ester oxygen of the carboxylate group is associated with a group comprising an aromatic group. Generally, the aromatic ester solvent is a liquid at room temperature and pressure. In some embodiments, the aromatic ester comprises the formula:

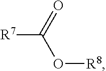

wherein R⁷ comprises an aromatic group and R⁸ is a suitable substituent. In some embodiments, R⁷ comprises an optionally substituted aryl. In some embodiments, R⁷ is an optionally substituted aryl. In some embodiments, R⁷ comprises an optionally substituted phenyl. In some embodiments, R⁷ is an optionally substituted phenyl. In some embodiments, R⁷ is substituted with —OH. In some embodiments, R⁷ is phenyl. In some embodiments, R⁷ is Ar—CH═CH—, wherein Ar is an aromatic group. In some embodiments Ar is optionally substituted phenyl. In some embodiments, Ar is phenyl. In some embodiments, R⁸ is selected from the group consisting of hydrogen, alkyl, optionally substituted alkyl, optionally substituted heteroalkyl, optionally substituted cycloalkyl, optionally substituted aryl, or optionally substituted heterocycle. In some embodiments, the optionally substituted heterocycle may be an optionally substituted cycloheteroalkyl or an optionally substituted heteroaryl. In some embodiments, R⁸ is an optionally substituted alkyl. In some embodiments, R⁸ is an alkyl substituted with an aryl group. In some embodiments, R⁸ is benzyl. In some embodiments, R⁸ is an unsubstituted alkyl. In some embodiments, R⁸ is methyl, ethyl, propyl (e.g., n-propyl, i-propyl), or butyl (e.g., n-butyl, i-butyl, t-butyl). In some embodiments, R⁸ is methyl.

In some embodiments, the aromatic ester solvent is selected from the group consisting of esters of salicylates, benzoates, cinnamates, and phthalates, or combinations thereof. Non-limiting specific examples of aromatic ester solvents include isomers of methyl salicylate, ethyl salicylate, benzyl salicylate, methyl benzoate, ethyl benzoate, benzyl benzoate, methyl cinnamate, ethyl cinnamate. Other aromatic esters include esters of phthalic acid, isophthalic acid, and terephthalic acid where the substituents are linear, branched, aromatic, or cyclic alcohols containing 1 to 13 carbons. Examples include, but are not limited to, 1,2-dimethylthalate, 1,3-dimethylphthalate, 1,4-dimethylphthalate, 1,2-diethylphthalate, 1,3-diethylphthalate, 1,4-diethylphthalate, di-(2-ethylhexyl) phthalate, butyl benzyl phthalate, 1,2-dibutyl phthalate, 1,2-dicotylphthalate. In certain embodiments the aromatic ester solvent is selected from the group consisting of benzyl benzoate and methyl salicylate, or combinations thereof. In certain embodiments, the aromatic ester solvent is benzyl benzoate. In certain embodiments, the aromatic ester solvent is methyl salicylate.

In some embodiments, the solvent blend may comprise a terpene. In some embodiments, the solvent blend may comprise an aliphatic hydrocarbon liquid. In some embodiments, the solvent blend may comprise a water-immiscible hydrocarbon liquid. In some embodiments, the first type of solvent in a non-aqueous solvent blend in the emulsion or microemulsion is a substance (e.g., a liquid) with a significant hydrophobic character with linear, branched, cyclic, bicyclic, saturated, or unsaturated structure, including terpenes and/or alkyl aliphatic carboxylic acid esters.

Examples of categories of solvent in the solvent blend include but are not limited to terpenes, terpineols, terpene alcohols, aldehydes, ketones, esters, amines, amides, terpenoids, alkyl aliphatic carboxylic acid esters, aliphatic hydrocarbon liquids, water immiscible hydrocarbon liquids, silicone fluids and combinations thereof.

Terpenes

In some embodiments, the first type of solvent comprises at least one terpene. In some embodiments, the first type of solvent is a terpene. In some embodiments, the first type of solvent comprises a first terpene and a second, different terpene.

Terpenes are generally derived biosynthetically from units of isoprene. Terpenes may be generally classified as monoterpenes (e.g., having two isoprene units), sesquiterpenes (e.g., having 3 isoprene units), diterpenes, or the like. The term “terpenoid” includes natural degradation products, such as ionones, and natural and synthetic derivatives, e.g., terpene alcohols, ethers, aldehydes, ketones, acids, esters, epoxides, and hydrogenation products (e.g., see Ullmann's Encyclopedia of Industrial Chemistry, 2012, pages 29-45, herein incorporated by reference). In some embodiments, the terpene is a naturally occurring terpene. In some embodiments, the terpene is a non-naturally occurring terpene and/or a chemically modified terpene (e.g., saturated terpene, terpene amine, fluorinated terpene, or silylated terpene). Terpenes that are modified chemically, such as by oxidation or rearrangement of the carbon skeleton, may be referred to as terpenoids. Many references use “terpene” and “terpenoid” interchangeably, and this disclosure will adhere to that usage.

In some embodiments, the terpene is a non-oxygenated terpene. In some embodiments, the terpene is citrus terpene. In some embodiments, the terpene is d-limonene. In some embodiments, the terpene is dipentene. In some embodiments, the terpene is selected from the group consisting of d-limonene, nopol, alpha terpineol, eucalyptol, dipentene, linalool, alpha-pinene, beta-pinene, alpha-terpinene, geraniol, alpha-terpinyl acetate, menthol, menthone, cineole, citranellol, and combinations thereof. As used herein, “terpene” refers to a single terpene compound or a blend of terpene compounds.

In some embodiments, the terpene is an oxygenated terpene. Non-limiting examples of oxygenated terpenes include terpenes containing alcohol, aldehyde, ether, or ketone groups. In some embodiments, the terpene comprises an ether-oxygen, for example, eucalyptol, or a carbonyl oxygen, for example, menthone. In some embodiments the terpene is a terpene alcohol. Non-limiting examples of terpene alcohols include linalool, geraniol, nopol, α-terpineol, and menthol. Non-limiting examples of oxygenated terpenes include eucalyptol, 1,8-cineol, menthone, and carvone.

Alkyl Aliphatic Carboxylic Acid Esters

In some embodiments, the solvent blend is or comprises an alkyl aliphatic carboxylic acid ester. As used herein “alkyl aliphatic carboxylic acid ester” refers to a compound or a blend of compounds having the general formula:

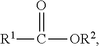

wherein R¹ is a C₆ to C₁₂ optionally substituted aliphatic group, including those bearing heteroatom-containing substituent groups, and R² is a C₁ to C₆ alkyl group. In some embodiments, R¹ is C₆ to C₁₂ alkyl. In some embodiments, R¹ is substituted with at least one heteroatom-containing substituent group. For example, wherein a blend of compounds is provided and each R² is —CH₃ and each R¹ is independently a C₆ to C₁₂ aliphatic group, the blend of compounds is referred to as methyl aliphatic carboxylic acid esters, or methyl esters. In some embodiments, such alkyl aliphatic carboxylic acid esters may be derived from a fully synthetic process or from natural products, and thus comprise a blend of more than one ester. In some embodiments, the alkyl aliphatic carboxylic acid ester comprises butyl 3-hydroxybutyrate, isopropyl 3-hydroxybutyrate, hexyl 3-hydroxylbutyrate, and combinations thereof.

Non-limiting examples of alkyl aliphatic carboxylic acid esters include methyl octanoate, methyl decanoate, a blend of methyl octanoate and methyl decanoate, and butyl 3-hydroxybutyrate.

Alkanes

In some embodiments, the solvent blend comprises an unsubstituted cyclic or acyclic, branched or unbranched alkane. In some embodiments, the cyclic or acyclic, branched or unbranched alkane has from 6 to 12 carbon atoms. Non-limiting examples of unsubstituted, acyclic, unbranched alkanes include hexane, heptane, octane, nonane, decane, undecane, dodecane, and combinations thereof. Non-limiting examples of unsubstituted, acyclic, branched alkanes include isomers of methylpentane (e.g., 2-methylpentane, 3-methylpentane), isomers of dimethylbutane (e.g., 2,2-dimethylbutane, 2,3-dimethylbutane), isomers of methylhexane (e.g., 2-methylhexane, 3-methylhexane), isomers of ethylpentane (e.g., 3-ethylpentane), isomers of dimethylpentane (e.g., 2,2,-dimethylpentane, 2,3-dimethylpentane, 2,4-dimethylpentane, 3,3-dimethylpentane), isomers of trimethylbutane (e.g., 2,2,3-trimethylbutane), isomers of methylheptane (e.g., 2-methylheptane, 3-methylheptane, 4-methylheptane), isomers of dimethylhexane (e.g., 2,2-dimethylhexane, 2,3-dimethylhexane, 2,4-dimethylhexane, 2,5-dimethylhexane, 3,3-dimethylhexane, 3,4-dimethylhexane), isomers of ethylhexane (e.g., 3-ethylhexane), isomers of trimethylpentane (e.g., 2,2,3-trimethylpentane, 2,2,4-trimethylpentane, 2,3,3-trimethylpentane, 2,3,4-trimethylpentane), isomers of ethylmethylpentane (e.g., 3-ethyl-2-methylpentane, 3-ethyl-3-methylpentane), and combinations thereof. Non-limiting examples of unsubstituted cyclic branched or unbranched alkanes include cyclohexane, methylcyclopentane, ethylcyclobutane, propylcyclopropane, isopropylcyclopropane, dimethylcyclobutane, cycloheptane, methylcyclohexane, dimethylcyclopentane, ethylcyclopentane, trimethylcyclobutane, cyclooctane, methylcycloheptane, dimethylcyclohexane, ethylcyclohexane, cyclononane, methylcyclooctane, dimethylcycloheptane, ethylcycloheptane, trimethylcyclohexane, ethylmethylcyclohexane, propylcyclohexane, cyclodecane, and combinations thereof. In some embodiments, the unsubstituted cyclic or acyclic, branched or unbranched alkane having from 6 to 12 carbon atoms is selected from the group consisting of heptane, octane, nonane, decane, 2,2,4-trimethylpentane (isooctane), and propylcyclohexane, and combinations thereof.

Unsaturated Hydrocarbon Solvents

In some embodiments, the solvent blend comprises an unsubstituted acyclic branched alkene or unsubstituted acyclic unbranched alkene having one or two double bonds and from 6 to 12 carbon atoms. In some embodiments, the solvent blend comprises an unsubstituted acyclic branched alkene or unsubstituted acyclic unbranched alkene having one or two double bonds and from 6 to 10 carbon atoms. Non-limiting examples of unsubstituted acyclic unbranched alkenes having one or two double bonds and from 6 to 12 carbon atoms include isomers of hexene (e.g., 1-hexene, 2-hexene), isomers of hexadiene (e.g., 1,3-hexadiene, 1,4-hexadiene), isomers of heptene (e.g., 1-heptene, 2-heptene, 3-heptene), isomers of heptadiene (e.g., 1,5-heptadiene, 1-6, heptadiene), isomers of octene (e.g., 1-octene, 2-octene, 3-octene), isomers of octadiene (e.g., 1,7-octadiene), isomers of nonene, isomers of nonadiene, isomers of decene, isomers of decadiene, isomers of undecene, isomers of undecadiene, isomers of dodecene, isomers of dodecadiene, and combinations thereof. In some embodiments, the acyclic, unbranched alkene having one or two double bonds and from 6 to 12 carbon atoms is an alpha-olefin (e.g., 1-hexene, 1-heptene, 1-octene, 1-nonene, 1-decene, 1-undecene, 1-dodecene). Non-limiting examples of unsubstituted, acyclic, branched alkenes include isomers of methylpentene, isomers of dimethylpentene, isomers of ethylpentene, isomers of methylethylpentene, isomers of propylpentene, isomers of methylhexene, isomers of ethylhexene, isomers of dimethylhexene, isomers of methylethylhexene, isomers of methylheptene, isomers of ethylheptene, isomers of dimethylhexptene, isomers of methylethylheptene, and combinations thereof. In a particular embodiment, the unsubstituted, acyclic, unbranched alkene having one or two double bonds and from 6 to 12 carbon atoms is 1-octene, 1,7-octadiene, or a combination thereof.

Aromatic Solvents

In some embodiments, the solvent blend comprises an aromatic solvent having a boiling point from about 300 to about 400 degrees Fahrenheit. Non-limiting examples of aromatic solvents having a boiling point from about 300 to about 400 degrees Fahrenheit include butylbenzene, hexylbenzene, mesitylene, light aromatic naphtha, heavy aromatic naphtha, and combinations thereof.

In some embodiments, the solvent blend comprises an aromatic solvent having a boiling point from about 175 to about 300 degrees Fahrenheit. Non-limiting examples of aromatic liquid solvents having a boiling point from about 175 to about 300 degrees Fahrenheit include benzene, xylenes, and toluene. In a particular embodiment, the solvent blend does not comprise toluene or benzene.

Dialkyl Ethers

In some embodiments, the solvent blend comprises a branched or unbranched dialkylether having the formula CₙH₂ₙ₊₁OCₘH₂ₘ₊₁ wherein n+m is from 6 to 16. In some embodiments, n+m is from 6 to 12, or from 6 to 10, or from 6 to 8. Non-limiting examples of branched or unbranched dialkylether compounds having the formula CₙH₂ₙ₊₁OCₘH₂ₘ₊₁ include isomers of C₃H₇OC₃H₇, isomers of C₄H₉OC₃H₇, isomers of C₅H₁₁OC₃H₇, isomers of C₆H₁₃OC₃H₇, isomers of C₄H₉OC₄H₉, isomers of C₄H₉OC₅Hᵢᵢ, isomers of C₄H₉OC₆H₁₃, isomers of C₅H₁₁OC₆H₁₃, and isomers of C₆H₁₃OC₆H₁₃. In a particular embodiment, the branched or unbranched dialklyether is an isomer of C₆H₁₃OC₆H₁₃ (e.g., dihexylether).

Bicyclic Hydrocarbon Solvents

In some embodiments, the solvent blend comprises a bicyclic hydrocarbon solvent with varying degrees of unsaturation including fused, bridgehead, and spirocyclic compounds. Non-limiting examples of bicyclic solvents include isomers of decalin, tetrahydronapthalene, norbornane, norbornene, bicyclo[4.2.0]octane, bicyclo[3.2.1]octane, spiro[5.5]dodecane, and combinations thereof.

In some embodiments, the solvent blend comprises a bicyclic hydrocarbon solvent with varying degrees of unsaturation and containing at least one O, N, or S atom including fused, bridgehead, and spirocyclic compounds. Non-limiting examples include isomers of 7 oxabicyclo[2.2.1]heptane, 4,7-epoxyisobenzofuran-1,3-dione, 7 oxabicyclo[2.2.1]heptane-2,3-dicarboxylic acid, 2,3-dimethyl ester, and combinations thereof.

Alcohols

In some embodiments, the solvent blend comprises a cyclic or acyclic, branched or unbranched alkane having from 6 to 12 carbon atoms and substituted with a hydroxyl group. Non-limiting examples of cyclic or acyclic, branched or unbranched alkanes having from 6 to 12 carbon atoms and substituted with a hydroxyl group include isomers of nonanol, isomers of decanol, isomers of undecanol, isomers of dodecanol, and combinations thereof. In a particular embodiment, the cyclic or acyclic, branched or unbranched alkane having from 9 to 12 carbon atoms and substituted with a hydroxyl group is 1-nonanol, 1-decanol, or a combination thereof.

Non-limiting examples of cyclic or acyclic, branched or unbranched alkanes having 8 carbon atoms and substituted with a hydroxyl group include isomers of octanol (e.g., 1-octanol, 2-octanol, 3-octanol, 4-octanol), isomers of methyl heptanol, isomers of ethylhexanol (e.g., 2-ethyl-1-hexanol, 3-ethyl-1-hexanol, 4-ethyl-1-hexanol), isomers of dimethylhexanol, isomers of propylpentanol, isomers of methylethylpentanol, isomers of trimethylpentanol, and combinations thereof. In a particular embodiment, the cyclic or acyclic, branched or unbranched alkane having 8 carbon atoms and substituted with a hydroxyl group is 1-octanol, 2-ethyl-1-hexanol, or a combination thereof.

Amine Solvents

In some embodiments, the solvent blend comprises an amine of the formula NR¹R²R³, wherein R¹, R², and R³ are the same or different and are C₁₋₁₆ alkyl groups that are (i) branched or unbranched; (ii) cyclic or acyclic; and (iii) substituted or unsubstituted. In some embodiments any two of R¹, R², and R³ are joined together to form a ring. In some embodiments, each of R¹, R², and R³ are the same or different and are hydrogen or alkyl groups that are (i) branched or unbranched; (ii) cyclic or acyclic; and (iii) substituted or unsubstituted. In some embodiments, any two of R¹, R², and R³ are joined together to form a ring, provided at least one of R¹, R², and R³ is a methyl or an ethyl group. In some embodiments, R¹ is C₁-C₆ alkyl group that is (i) branched or unbranched; (ii) cyclic or acyclic; and (iii) substituted or unsubstituted and R² and R³ are hydrogen or a C₈₋₁₆ alkyl group that is (i) branched or unbranched; (ii) cyclic or acyclic; and (iii) substituted or unsubstituted. In some embodiments, R² and R³ may be joined together to form a ring. In some embodiments, R¹ is a methyl or an ethyl group and R² and R³ are the same or different and are C₈₋₁₆ alkyl groups that are (i) branched or unbranched; (ii) cyclic or acyclic; and (iii) substituted or unsubstituted. In some embodiments R² and R³ may be joined together to form a ring. In some embodiments, R¹ is a methyl group and R² and R³ are the same or different and are hydrogen or C₈₋₁₆ alkyl groups that are (i) branched or unbranched; (ii) cyclic or acyclic; and (iii) substituted or unsubstituted. In some embodiments R² and R³ may be joined together to form a ring. In some embodiments, R¹ and R² are the same or different and are hydrogen or C₁-C₆ alkyl groups that are (i) branched or unbranched; (ii) cyclic or acyclic; and (iii) substituted or unsubstituted and R³ is a C₈₋₁₆ alkyl group that is (i) branched or unbranched; (ii) cyclic or acyclic; and (iii) substituted or unsubstituted. In some embodiments, R¹ and R² are the same or different and are a methyl or an ethyl group and R³ is hydrogen or a C₈₋₁₆ alkyl group that is (i) branched or unbranched; (ii) cyclic or acyclic; and (iii) substituted or unsubstituted. In some embodiments, R¹ and R² are methyl groups and R³ is hydrogen or a C₈₋₁₆ alkyl group that is (i) branched or unbranched; (ii) cyclic or acyclic; and (iii) substituted or unsubstituted.

In some embodiments, the amine is of the formula NR¹R²R³, wherein R¹ is methyl and R² and R³ are C₈₋₁₆ alkyl groups that are (i) branched or unbranched; (ii) cyclic or acyclic; and (iii) substituted or unsubstituted. In some embodiments R² and R³ are joined together to form a ring. Non-limiting examples of amines include isomers of N-methyl-octylamine, isomers of N-methyl-nonylamine, isomers of N-methyl-decylamine, isomers of N-methylundecylamine, isomers of N-methyldodecylamine, isomers of N-methyl teradecylamine, isomers of N-methyl-hexadecylamine, and combinations thereof. In some embodiments, the amine is N-methyl-decylamine, N-methyl-hexadecylamine, or a combination thereof.

In some embodiments, the amine is of the formula NR¹R²R³, wherein R¹ is a methyl group and R² and R³ are the same or different and are C₈₋₁₆ alkyl groups that are (i) branched or unbranched; (ii) cyclic or acyclic; and (iii) substituted or unsubstituted. In some embodiments R² and R³ are joined together to form a ring. Non-limiting examples of amines include isomers of N-methyl-N-octyloctylamine, isomers of N-methyl-N-nonylnonylamine, isomers of N-methyl-N-decyldecylamine, isomers of N-methyl-N-undecylundecylamine, isomers of N-methyl-N-dodecyldodecylamine, isomers of N-methyl-N-tetradecylteradecylamine, isomers of N-methyl-N-hexadecylhexadecylamine, isomers of N-methyl-N-octylnonylamine, isomers of N-methyl-N-octyldecylamine, isomers of N-methyl-N-octyldodecylamine, isomers of N-methyl-N-octylundecylamine, isomers of N-methyl-N-octyltetradecylamine, isomers of N-methyl-N-octylhexadecylamine, N-methyl-N-nonyldecylamine, isomers of N-methyl-N-nonyldodecylamine, isomers of N-methyl-N-nonyltetradecylamine, isomers of N-methyl-N-nonylhexadecylamine, isomers of N-methyl-N-decylundecylamine, isomers of N-methyl-N-decyldodecylamine, isomers of N-methyl-N-decyltetradecylamine, isomers of N-methyl-N-decylhexadecylamine, isomers of N-methyl-N-dodecylundecylamine, isomers of N-methyl-N-dodecyltetradecylamine, isomers of N-methyl-N-dodecylhexadecylamine, isomers of N-methyl-N-tetradecylhexadecylamine, and combinations thereof. In some embodiments, the amine is selected from the group consisting of N-methyl-N-octyloctylamine, isomers of N-methyl-N-nonylnonylamine, isomers of N-methyl N-decyldecylamine, isomers of N-methyl-N-undecylundecylamine, isomers of N-methyl-N-dodecyldodecylamine, isomers of N-methyl-N-tetradecylteradecylamine, and isomers of N-methyl-N-hexadecylhexadecylamine, and combinations thereof. In some embodiments, the amine is N-methyl-N-dodecyldodecylamine, one or more isomers of N-methyl-N-hexadecylhexadecylamine, or combinations thereof. In some embodiments, the amine is selected from the group consisting of isomers of N-methyl-N-octylnonylamine, isomers of N-methyl-N-octyldecylamine, isomers of N-methyl-N-octyldodecylamine, isomers of N-methyl-N-octylundecylamine, isomers of N-methyl-N-octyltetradecylamine, isomers of N-methyl-N-octylhexadecylamine, N-methyl-N-nonyldecylamine, isomers of N-methyl-N-nonyldodecylamine, isomers of N-methyl-N-nonyltetradecylamine, isomers of N-methyl-N-nonylhexadecylamine, isomers of N-methyl-N-decyldodecylamine, isomers of N-methyl-N-decylundecylamine, isomers of N-methyl-N-decyldodecylamine, isomers of N-methyl-N-decyltetradecylamine, isomers of N-methyl-N-decylhexadecylamine, isomers of N-methyl-N-dodecylundecylamine, isomers of N-methyl-N-dodecyltetradecylamine, isomers of N-methyl-N-dodecylhexadecylamine, isomers of N-methyl-N-tetradecylhexadecylamine, and combinations thereof. In some embodiments, the cyclic or acyclic, branched or unbranched tri-substituted amine is selected from the group consisting of N-methyl-N-octyldodecylamine, N-methyl-N-octylhexadecylamine, and N-methyl-N-dodecylhexadecylamine, and combinations thereof.

In some embodiments, the amine is of the formula NR¹R²R³, wherein R¹ and R² are methyl and R³ is a C₈₋₁₆ alkyl that is (i) branched or unbranched; (ii) cyclic or acyclic; and (iii) substituted or unsubstituted. Non-limiting examples of amines include isomers of N,N-dimethylnonylamine, isomers of N,N-dimethyldecylamine, isomers of N,N-dimethylundecylamine, isomers of N,N-dimethyldodecylamine, isomers of N,N-dimethyltetradecylamine, and isomers of N,N-dimethylhexadecylamine. In some embodiments, the amine is selected from the group consisting of N,N-dimethyldecylamine, isomers of N,N-dodecylamine, and isomers of N,N-dimethylhexadecylamine.

Amide Solvents

In some embodiments, the solvent blend comprises an amide solvent. In some embodiments, the amide is of the formula N(C═OR⁴)R⁵R⁶, wherein R⁴, R⁵, and R⁶ are the same or different and are hydrogen or C₄₋₁₆ alkyl groups wherein the alkyl groups are (i) branched or unbranched; (ii) cyclic or acyclic; and (iii) substituted or unsubstituted. In some embodiments R⁵ and R⁶ are joined together to form a ring. In some embodiments, each of R⁴, R⁵, and R⁶ are the same or different and are hydrogen or C₄₋₁₆ alkyl groups wherein the alkyl groups are (i) branched or unbranched; (ii) cyclic or acyclic; and (iii) substituted or unsubstituted, provided at least one of R⁴, R⁵, and R⁶ is a methyl or an ethyl group. In some embodiments R⁵ and R⁶ are joined together to form a ring. In some embodiments, R⁴ is hydrogen, C₁-C₆ alkyl, wherein the alkyl group is (i) branched or unbranched; (ii) cyclic or acyclic; and (iii) substituted or unsubstituted, and R⁵ and R⁶ are the same or different and are hydrogen or C₈₋₁₆ alkyl groups wherein the alkyl groups are (i) branched or unbranched; (ii) cyclic or acyclic; and (iii) substituted or unsubstituted. In some embodiments, R⁵ and R⁶ are joined together to form a ring. In some embodiments, R⁴ is hydrogen, methyl, or ethyl and R⁵ and R⁶ are C₈₋₁₆ alkyl groups wherein the alkyl groups are (i) branched or unbranched; (ii) cyclic or acyclic; and (iii) substituted or unsubstituted. In some embodiments, R⁵ and R⁶ are joined together to form a ring. In some embodiments, R⁴ is hydrogen and R⁵ and R⁶ are the same or different and are C₈₋₁₆ alkyl groups wherein the alkyl groups are (i) branched or unbranched; (ii) cyclic or acyclic; and (iii) substituted or unsubstituted. In some embodiements R⁵ and R⁶ are joined together to form a ring. In some embodiments, R⁴ and R⁵ are the same or different and are hydrogen or C₁-C₆ alkyl groups wherein the alkyl groups are (i) branched or unbranched; (ii) cyclic or acyclic; and (iii) substituted or unsubstituted and R⁶ is a C₈₋₁₆ alkyl group that is (i) branched or unbranched; (ii) cyclic or acyclic; and (iii) substituted or unsubstituted. In some embodiments, R⁴ and R⁵ are the same or different and are independently hydrogen, methyl, or ethyl and R⁶ is a C₈₋₁₆ alkyl group that is (i) branched or unbranched; (ii) cyclic or acyclic; and (iii) substituted or unsubstituted. In some embodiments, R⁴ and R⁵ are hydrogen and R⁶ is a C₈₋₁₆ alkyl group that is (i) branched or unbranched; (ii) cyclic or acyclic; and (iii) substituted or unsubstituted. In some embodiments, R⁶ is hydrogen or R⁶ is a C₁₋₆ alkyl group that is (i) branched or unbranched; (ii) cyclic or acyclic; and (iii) substituted or unsubstituted and R⁴ and R⁵ are the same or different and are C₈₋₁₆ alkyl groups wherein the alkyl groups are (i) branched or unbranched; (ii) cyclic or acyclic; and (iii) substituted or unsubstituted. In some embodiments, R⁶ is hydrogen, methyl, or ethyl and R⁴ and R⁵ are the same or different and are C₈₋₁₆ alkyl groups wherein the alkyl groups are (i) branched or unbranched; (ii) cyclic or acyclic; and (iii) substituted or unsubstituted. In some embodiments, R⁶ is hydrogen and R⁴ and R⁵ are the same or different and are C₈₋₁₆ alkyl groups wherein the alkyl groups are (i) branched or unbranched; (ii) cyclic or acyclic; and (iii) substituted or unsubstituted. In some embodiments, R⁵ and R⁶ are the same or different and are hydrogen or C₁₋₆ alkyl groups wherein the alkyl groups are (i) branched or unbranched; (ii) cyclic or acyclic; and (iii) substituted or unsubstituted, and R⁴ is a C₈₋₁₆ alkyl group that is (i) branched or unbranched; (ii) cyclic or acyclic; and (iii) substituted or unsubstituted. In some embodiments, R⁵ and R⁶ are the same or different and are independently hydrogen, methyl, or ethyl and R⁴ is a C₈₋₁₆ alkyl group that is (i) branched or unbranched; (ii) cyclic or acyclic; and (iii) substituted or unsubstituted. In some embodiments, R⁵ and R⁶ are hydrogen and R⁴ is a C₈₋₁₆ alkyl group that is (i) branched or unbranched; (ii) cyclic or acyclic; and (iii) substituted or unsubstituted.

In some embodiments, the amide is of the formula N(C═OR⁴)R⁵R⁶, wherein each of R⁴, R⁵, and R⁶ are the same or different and are C₄₋₁₆ alkyl groups wherein the alkyl groups are (i) branched or unbranched; (ii) cyclic or acyclic; and (iii) substituted or unsubstituted. In some embodiments R⁵ and R⁶ are joined together to form a ring. In some embodiments, the amide is of the formula N(C═O R⁴)R⁵R⁶, wherein each of R⁴, R⁵, and R⁶ are the same or different and are C₈₋₁₆ alkyl groups wherein the alkyl groups are (i) branched or unbranched; (ii) cyclic or acyclic; and (iii) substituted or unsubstituted. In some embodiments R⁵ and R⁶ are joined together to form a ring. Non-limiting examples of amides include N,N-dioctyloctamide, N,N-dinonylnonamide, N,N-didecyldecamide, N,N-didodecyldodecamide, N,N-diundecylundecamide, N,N-ditetradecyltetradecamide, N,N-dihexadecylhexadecamide, N,N-didecyloctamide, N,N-didodecyloctamide, N,N-dioctyldodecamide, N,N-didecyldodecamide, N,N-dioctylhexadecamide, N,N-didecylhexadecamide, N,N-didodecylhexadecamide, and combinations thereof. In some embodiments, the amide is N,N-dioctyldodecamide, N,N-didodecyloctamide, or a combination thereof.

In some embodiments, the amide is of the formula N(C═OR⁴)R⁵R⁶, wherein R⁶ is selected from the group consisting of hydrogen, methyl, ethyl, propyl and isopropyl, and R⁴ and R⁵ are the same or different and are C₄₋₁₆ alkyl groups wherein the alkyl groups are (i) branched or unbranched; (ii) cyclic or acyclic; and (iii) substituted or unsubstituted. In some embodiments, R⁶ is selected from the group consisting of hydrogen, methyl, ethyl, propyl and isopropyl, and R⁴ and R⁵ are the same or different and are C₄₋₈ alkyl groups wherein the alkyl groups are (i) branched or unbranched; (ii) cyclic or acyclic; and (iii) substituted or unsubstituted. In some embodiments, at least one of R⁴ and R⁵ is substituted with a hydroxyl group. In some embodiments, at least one of R⁴ and R⁵ is C₁₋₁₆ alkyl substituted with a hydroxyl group.

In some embodiments, the amide is of the formula N(C═OR⁴)R⁵R⁶, wherein R⁶ is C₁-C₃ alkyl and R⁴ and R⁵ are the same or different and are C₄₋₁₆ alkyl groups that are (i) branched or unbranched; (ii) cyclic or acyclic; and (iii) substituted or unsubstituted. In some embodiments, R⁶ is selected from the group consisting of methyl, ethyl, propyl, and isopropyl, and R⁴ and R⁵ are the same or different and are C₄₋₁₆ alkyl groups that are (i) branched or unbranched; (ii) cyclic or acyclic; and (iii) substituted or unsubstituted. In some embodiments, R⁶ is selected from the group consisting of methyl, ethyl, propyl, and isopropyl, and R⁴ and R⁵ are the same or different and are C₈₋₁₆ alkyl groups that are (i) branched or unbranched; (ii) cyclic or acyclic; and (iii) substituted or unsubstituted. In some embodiments, at least one of R⁴ and R⁵ is substituted with a hydroxyl group. In some embodiments, R⁶ is selected from the group consisting of methyl, ethyl, propyl, and isopropyl, and R⁴ and R⁵ are the same or different and are C₄₋₁₆ alkyl groups that are (i) branched or unbranched; (ii) cyclic or acyclic; and (iii) substituted or unsubstituted. In some embodiments at least one of R⁴ and R⁵ is C₁₋₁₆ alkyl substituted with a hydroxyl group.

Non-limiting examples of amides include N,N-di-tert-butylformamide, N,N-dipentylformamide, N,N-dihexylformamide, N,N-diheptylformamide, N,N-dioctylformamide, N,N-dinonylformamide, N,N-didecylformamide, N,N-diundecylformamide, N,N-didodecylformamide, N,N-dihydroxymethylformamide, N,N-di-tert-butylacetamide, N,N-dipentylacetamide, N,N-dihexylacetamide, N,N-diheptylacetamide, N,N-dioctylacetamide, N,N-dinonylacetamide, N,N-didecylacetamide, N,N-diundecylacetamide, N,N-didodecylacetamide, N,N-dihydroxymethylacetamide, N,N-dimethylpropionamide, N,N-diethylpropionamide, N,N-dipropylpropionamide, N,N-di-n-propylpropionamide N,N-diisopropylpropionamide, N,N-dibutylpropionamide, N,N-di-n-butylpropionamide, N,N-di-sec-butylpropionamide, N,N-diisobutylpropionamide or N,N-di-tert-butylpropionamide, N,N-dipentylpropionamide, N,N-dihexylpropionamide, N,N-diheptylpropionamide, N,N-dioctylpropionamide, N,N-dinonylpropionamide, N,N-didecylpropionamide, N,N-diundecylpropionamide, N,N-didodecylpropionamide, N,N-dimethyl-n-butyramide, N,N-diethyl-n-butyramide, N,N-dipropyl-n-butyramide, N,N-di-n-propyl-n-butyramide or N,N-diisopropyl-n-butyramide, N,N-dibutyl-n-butyramide, N,N-di-n-butyl-n-butyramide, N,N-di-sec-butyl-n-butyramide, N,N-diisobutyl-n-butyramide, N,N-di-tert-butyl-n-butyramide, N,N-dipentyl-n-butyramide, N,N-dihexyl-n-butyramide, N,N-diheptyl-n-butyramide, N,N-dioctyl-n-butyramide, N,N-dinonyl-n-butyramide, N,N-didecyl-n-butyramide, N,N-diundecyl-n-butyramide, N,N-didodecyl-n-butyramide, N,N-dipentylisobutyramide, N,N-dihexylisobutyramide, N,N-diheptylisobutyramide, N,N-dioctylisobutyramide, N,N-dinonylisobutyramide, N,N-didecylisobutyramide, N,N-diundecylisobutyramide, N,N-didodecylisobutyramide, N,N-pentylhexylformamide, N,N-pentylhexylacetamide, N,N-pentylhexylpropionamide, N,N-pentylhexyl-n-butyramide, N,N-pentylhexylisobutyramide, N,N-methylethylpropionamide, N,N-methyl-n-propylpropionamide, N,N-methylisopropylpropionamide, N,N-methyl-n-butylpropionamide, N,N-methylethyl-n-butyramide, N,N-methyl-n-butyramide, N,N-methylisopropyl-n-butyramide, N,N-methyl-n-butyl-n-butyramide, N,N-methylethylisobutyramide, N,N-methyl-n-propylisobutyramide, N,N-methylisopropylisobutyramide, and N,N-methyl-n-butylisobutyramide. In some embodiments, the amide is selected from the group consisting of N,N-dioctyldodecacetamide, N,N-methyl-N-octylhexadecdidodecylacetamide, N-methyl-N-hexadecyldodecylhexadecacetamide, and combinations thereof.

In some embodiments, the amide is of the formula N(C═OR⁴)R⁵R⁶, wherein R⁶ is hydrogen or a methyl group and R⁴ and R⁵ are C₈₋₁₆ alkyl groups that are (i) branched or unbranched; (ii) cyclic or acyclic; and (iii) substituted or unsubstituted. Non-limiting amides include isomers of N-methyloctamide, isomers of N-methylnonamide, isomers of N-methyldecamide, isomers of N-methylundecamide, isomers of N methyldodecamide, isomers of N methylteradecamide, and isomers of N-methyl-hexadecamide. In some embodiments, the amides are selected from the group consisting of N-methyloctamide, N-methyldodecamide, N-methylhexadecamide, and combinations thereof.

Non-limiting amides include isomers of N-methyl-N-octyloctamide, isomers of N-methyl-N-nonylnonamide, isomers of N-methyl-N-decyldecamide, isomers of N methyl-N undecylundecamide, isomers of N methyl-N-dodecyldodecamide, isomers of N methyl N-tetradecylteradecamide, isomers of N-methyl-N-hexadecylhdexadecamide, isomers of N-methyl-N-octylnonamide, isomers of N-methyl-N-octyldecamide, isomers of N-methyl-N-octyldodecamide, isomers of N-methyl-N-octylundecamide, isomers of N-methyl-N-octyltetradecamide, isomers of N-methyl-N-octylhexadecamide, N-methyl-N-nonyldecamide, isomers of N-methyl-N-nonyldodecamide, isomers of N-methyl-N-nonyltetradecamide, isomers of N-methyl-N-nonylhexadecamide, isomers of N-methyl-N-decyldodecamide, isomers of N methyl-N-decylundecamide, isomers of N-methyl-N-decyldodecamide, isomers of N-methyl-N-decyltetradecamide, isomers of N-methyl-N-decylhexadecamide, isomers of N methyl-N-dodecylundecamide, isomers of N methyl-N-dodecyltetradecamide, isomers of N-methyl-N-dodecylhexadecamide, isomers of N methyl-N-tetradecylhexadecamide, and combinations thereof. In some embodiments, the amide is selected from the group consisting of isomers of N-methyl-N-octyloctamide, isomers of N-methyl-N-nonylnonamide, isomers of N-methyl-N-decyldecamide, isomers of N methyl-N undecylundecamide, isomers of N methyl-N-dodecyldodecamide, isomers of N methyl N-tetradecylteradecamide, isomers of N-methyl-N-hexadecylhdexadecamide, and combinations thereof. In some embodiments, amide is selected from the group consisting of N-methyl-N-octyloctamide, N methyl-N-dodecyldodecamide, and N-methyl-N-hexadecylhexadecamide. In some embodiments, the amide is selected from the group consisting of isomers of N-methyl-N-octylnonamide, isomers of N-methyl-N-octyldecamide, isomers of N-methyl-N-octyldodecamide, isomers of N-methyl-N-octylundecamide, isomers of N-methyl-N-octyltetradecamide, isomers of N-methyl-N-octylhexadecamide, N-methyl-N-nonyldecamide, isomers of N-methyl-N-nonyldodecamide, isomers of N-methyl-N-nonyltetradecamide, isomers of N-methyl-N-nonylhexadecamide, isomers of N-methyl-N-decyldodecamide, isomers of N methyl-N-decylundecamide, isomers of N-methyl-N-decyldodecamide, isomers of N-methyl-N-decyltetradecamide, isomers of N-methyl-N-decylhexadecamide, isomers of N methyl-N-dodecylundecamide, isomers of N methyl-N-dodecyltetradecamide, isomers of N-methyl-N-dodecylhexadecamide, and isomers of N methyl-N-tetradecylhexadecamide. In some embodiments, the amide is selected from the group consisting of N-methyl-N-octyldodecamide, N-methyl-N-octylhexadecamide, and N-methyl-N-dodecylhexadecamide.

In some embodiments, the amide is of the formula N(C═OR⁴)R⁵R⁶, wherein R⁵ and R⁶ are the same or different and are hydrogen or C₁-C₃ alkyl groups and R⁴ is a C₄₋₁₆ alkyl group that is (i) branched or unbranched; (ii) cyclic or acyclic; and (iii) substituted or unsubstituted. In some embodiments, R⁵ and R⁶ are the same or different and are selected from the group consisting of hydrogen, methyl, ethyl, propyl and isopropyl, and R⁴ is a C₄₋₁₆ alkyl group that is (i) branched or unbranched; (ii) cyclic or acyclic; and (iii) substituted or unsubstituted. In some embodiments, R⁵ and R⁶ are the same or different and are selected from the group consisting of hydrogen, methyl, ethyl, propyl and isopropyl and R⁴ is a C₈₋₁₆ alkyl group that is (i) branched or unbranched; (ii) cyclic or acyclic; and (iii) substituted or unsubstituted. In some embodiments, R⁴ is substituted with a hydroxyl group. In some embodiments, R⁵ and R⁶ are the same or different and are selected from the group consisting of hydrogen, methyl, ethyl, propyl, and isopropyl, and R⁴ is selected from the group consisting of tert-butyl and C₅₋₁₆ alkyl groups that are (i) branched or unbranched; (ii) cyclic or acyclic; and (iii) substituted or unsubstituted, and C₁₋₁₆ alkyl groups that are (i) branched or unbranched; (ii) cyclic or acyclic; and (iii) substituted with a hydroxyl group.

In some embodiments, the amide is of the formula N(C═OR⁴)R⁵R⁶, wherein R⁵ and R⁶ are methyl groups and R⁴ is a C₈₋₁₆ alkyl group that is (i) branched or unbranched; (ii) cyclic or acyclic; and (iii) substituted or unsubstituted. Non-limiting examples of amides include isomers of N,N-dimethyloctamide, isomers of N,N-dimethylnonamide, isomers of N,N-dimethyldecamide, isomers of N,N-dimethylundecamide, isomers of N,N-dimethyldodecamide, isomers of N,N-dimethyltetradecamide, isomers of N,N-dimethylhexadecamide, and combinations thereof. In some embodiments, the cyclic or acyclic, branched or unbranched tri-substituted amines is selected from the group consisting of N,N-dimethyloctamide, N,N-dodecamide, and N,N-dimethylhexadecamide.

Silicone Solvents

In some embodiments, the solvent blend in the emulsion or microemulsion comprises a methyl siloxane solvent. The emulsion or microemulsion may comprise a single methyl siloxane solvent or a combination of two or more methyl siloxane solvents. Methyl siloxane solvents may be classified as linear, cyclic, or branched. Methyl siloxane solvents are a class of oligomeric liquid silicones that possess the characteristics of low viscosity and high volatility. Non-limiting examples of linear siloxane solvents include hexamethyldisiloxane, octamethyltrisiloxane, decamethyltetrasiloxane, and dodecamethylpentasiloxane. Non-limiting examples of cyclic siloxane solvents include octamethylcyclotetrasiloxane, decamethylcyclopentasiloxane, and dodecamethylcyclohexasiloxane.

In some embodiments the siloxane solvent comprises a first type of siloxane solvent and a second type of siloxane solvent.

The siloxanes used in this embodiment can be linear methyl siloxanes, cyclic methyl siloxanes, branched methyl siloxanes, and combinations thereof. The linear methyl siloxanes have the formula

(CH₃)₃SiO{(CH₃)₂SiO}ₖSi(CH₃)₃

wherein the value of k is 0-5. The cyclic methyl siloxanes have the formula

{(CH₃)₂SiO}ₜ

wherein the value of t is 3-6. Preferably, these methyl siloxanes have a boiling point less than about 250° C. and viscosity of about 0.65 to about 5.0 cSt.

Some representative linear methyl siloxanes are hexamethyldisiloxane with a boiling point of 100 degrees Celsius, viscosity of 0.65 cSt, and structure

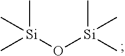

octamethyltrisiloxane with a boiling point of 152 degrees Celsius, viscosity of 1.04 cSt, and structure

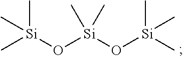

decamethyltetrasiloxane with a boiling point of 194 degrees Celsius, viscosity of 1.53 cSt, and structure

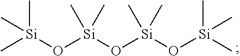

dodecamethylpentasiloxane with a boiling point of 229 degrees Celsius, viscosity of 2.06 cSt, and structure

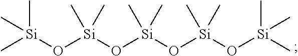

tetradecamethylhexasiloxane with a boiling point of 245 degrees Celsius, viscosity of 2.63 cSt, and structure

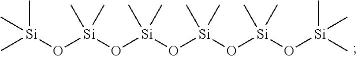

and hexadecamethylheptasiloxane with a boiling point of 270 degrees Celsius, viscosity of 3.24 cSt, and structure

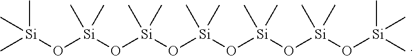

Some representative cyclic methyl siloxanes are hexamethylcyclotrisiloxane with a boiling point of 134 degrees Celsius and structure

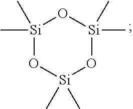

octamethylcyclotetrasiloxane with a boiling point of 176 degrees Celsius, viscosity of 2.3 cSt, and structure

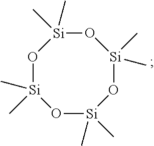

decamethylcyclopentasiloxane with a boiling point of 210 degrees Celsius, viscosity of 3.87 cSt, and structure

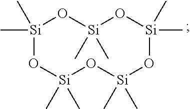

and dodecamethylcyclohexasiloxane with a boiling point of 245 degrees Celsius, viscosity of 6.62 cSt, and structure

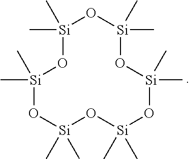

In some embodiments, a solvent (e.g., a terpene) may be extracted from a natural source (e.g., citrus, pine), and may comprise one or more impurities present from the extraction process. In some embodiments, the solvent comprises a crude cut (e.g., uncut crude oil, e.g., made by settling, separation, heating, etc.). In some embodiments, the solvent is a crude oil (e.g., naturally occurring crude oil, uncut crude oil, crude oil extracted from the wellbore, synthetic crude oil, crude citrus oil, crude pine oil, eucalyptus, etc.). In some embodiments, the solvent comprises a citrus extract (e.g., crude orange oil, orange oil, etc.). In some embodiments, the solvent is a citrus extract (e.g., crude orange oil, orange oil, etc.).

In some embodiments, the non-aqueous solvent blend may further comprise a third type of solvent. Non-limiting examples of the third type of solvent include plant-based methyl esters (e.g. soy methyl ester, canola methyl ester), alcohols, amides, and hydrocarbons, or combinations thereof. In some embodiments, the third type of solvent is an alkyl aliphatic ester solvent. In some embodiments, the alkyl aliphatic ester solvent is a methyl ester. In some embodiments, the third type of solvent is selected from the group consisting of soy methyl ester, canola methyl ester, octanoic acid methyl ester, decanoic acid methyl ester, dodecanoic acid methyl ester, palm methyl ester, and coconut methyl ester, or combinations thereof. In some embodiments, the third type of solvent is butyl 3-hydroxybutanoate. Without wishing to be bound by theory, the third type of solvent (e.g., alkyl aliphatic ester solvent) may serve as a coupling agent between the other components of the solvent blend and the one or more surfactant. In some embodiments, the third type of solvent may be an alcohol. In some embodiments, the alcohol is selected from the group consisting of primary, secondary, and tertiary alcohols having from 1 to 20 carbon atoms. Non-limiting examples of alcohols include methanol, ethanol, isopropanol, n-propanol, n-butanol, i-butanol, sec-butanol, iso-butanol, t-butanol, ethylene glycol, propylene glycol, dipropylene glycol monomethyl ether, triethylene glycol, and ethylene glycol monobutyl ether.

In some embodiments, an emulsion or microemulsion comprises an aqueous phase. Generally, the aqueous phase comprises water. The water may be provided from any suitable source (e.g., sea water, fresh water, deionized water, reverse osmosis water, water from field production). In some embodiments, the emulsion or microemulsion comprises from about 1 wt % to about 60 wt %, or from about 10 wt % to about 55 wt %, or from about 15 wt % to about 45 wt %, or from about 25 wt % to about 45 wt % of water, versus the total weight of the emulsion or microemulsion composition. The aqueous phase may comprise dissolved salts. Non-limiting examples of dissolved salts include salts comprising K, Na, Br, Cr, Cs, or Bi, for example, halides of these metals, including NaCl, KCl, CaCl₂, and MgCl and combinations thereof.

Generally, the emulsion or microemulsion comprises a surfactant. In some embodiments, the emulsion or microemulsion comprises a first surfactant and a second surfactant. In some embodiments the emulsion or microemulsion comprises a first surfactant and a co-surfactant. In some embodiments the emulsion or microemulsion comprises a first surfactant, a second surfactant and a co-surfactant. The term surfactant is given its ordinary meaning in the art and generally refers to compounds having an amphiphilic structure which gives them a specific affinity for oil/water-type and water/oil-type interfaces. In some embodiments, the affinity helps the surfactants to reduce the free energy of these interfaces and to stabilize the dispersed phase of an emulsion or microemulsion.

The term surfactant includes but is not limited to nonionic surfactants, anionic surfactants, cationic surfactants, amphoteric surfactants, zwitterionic surfactants, switchable surfactants, cleavable surfactants, dimeric or gemini surfactants, glucamide surfactants, alkylpolyglycoside surfactants, extended surfactants containing a nonionic spacer arm central extension and an ionic or nonionic polar group, and combinations thereof. Nonionic surfactants generally do not contain any charges. Anionic surfactants generally possess a net negative charge. Cationic surfactants generally possess a net positive charge. Amphoteric surfactants generally have both positive and negative charges, however, the net charge of the surfactant can be positive, negative, or neutral, depending on the pH of the solution. Zwitterionic surfactants are generally not pH dependent. A zwitterion is a neutral molecule with a positive and a negative electrical charge, though multiple positive and negative charges can be present.

“Extended surfactants” are defined herein to be surfactants having propoxylated/ethoxylated spacer arms. The extended chain surfactants are intramolecular mixtures having at least one hydrophilic portion and at least one lipophilic portion with an intermediate polarity portion in between the hydrophilic portion and the lipophilic portion; the intermediate polarity portion may be referred to as a spacer. They attain high solubilization in the single phase emulsion or microemulsion, and are in some instances, insensitive to temperature and are useful for a wide variety of oil types, such as natural or synthetic polar oil types in a non-limiting embodiment. More information related to extended chain surfactants may be found in U.S. Pat. No. 8,235,120, which is incorporated herein by reference in its entirety.

The term co-surfactant as used herein is given its ordinary meaning in the art and refers to compounds (e.g., pentanol) that act in conjunction with surfactants to form an emulsion or microemulsion.

In some embodiments, the one or more surfactants is a surfactant described in U.S. patent application Ser. No. 14/212,731, filed Mar. 14, 2014, entitled “METHODS AND COMPOSITIONS FOR USE IN OIL AND/OR GAS WELLS,” now published as US/2014/0284053 on Sep. 25, 2014, herein incorporated by reference. In some embodiments, the surfactant is a surfactant described in U.S. patent application Ser. No. 14/212,763, filed Mar. 14, 2014, entitled “METHODS AND COMPOSITIONS FOR USE IN OIL AND/OR GAS WELLS,” now published as US/2014/0338911 on Nov. 20, 2014, herein incorporated by reference.

In some embodiments, the emulsion or microemulsion comprises from about 0.1 wt % to about 10 wt %, or from about 0.1 wt % to about 8 wt %, or from about 0.1 wt % to about 6 wt %, or from about 0.1 wt % to about 4 wt %, or from about 0.1 wt % to about 3 wt %, or from about 0.1 wt % to about 2 wt % of the one or more surfactants, versus the total weight of the emulsion or microemulsion.

In some embodiments, the emulsion or microemulsion comprises from about 1 wt % to about 50 wt %, or from about 1 wt % to about 40 wt %, or from about 1 wt % to about 35 wt %, or from about 5 wt % to about 40 wt %, or from about 5 wt % to about 35 wt %, or from about 10 wt % to about 30 wt % of the surfactant versus the total weight of the emulsion or microemulsion.

In some embodiments, the emulsion or microemulsion comprises from about 5 wt % to about 65 wt %, or from about 5 wt % to about 60 wt %, or from about 5 wt % to about 50 wt %, or from about 5 wt % to about 40 wt %, or from about 10 wt % to about 55 wt %, or from about 10 wt % to about 30 wt % of the surfactant, versus the total weight of the emulsion or microemulsion composition.

In some embodiments, the surfactants described herein in conjunction with solvents, generally form emulsions or microemulsions that may be diluted to a use concentration to form an oil-in-water nanodroplet dispersion. In some embodiments, the surfactants generally have hydrophile-lipophile balance (HLB) values from 8 to 18, or from 8 to 14.

Hydrocarbon Surfactants

Suitable surfactants for use with the compositions and methods are generally described herein. In some embodiments, the surfactant comprises a hydrophilic hydrocarbon surfactant.

Nonionic Surfactants

In some embodiments, the surfactant comprises a nonionic surfactant. In some embodiments, the surfactant is an alkoxylated aliphatic alcohol having from 3 to 40 ethylene oxide (EO) units and from 0 to 20 propylene oxide (PO) units. The term aliphatic alcohol generally refers to a branched or linear, saturated or unsaturated aliphatic moiety having from 6 to 18 carbon atoms.

In some embodiments, the hydrophilic hydrocarbon surfactant comprises an alcohol ethoxylate, wherein the alcohol ethoxylate contains a hydrocarbon group of 10 to 18 carbon atoms and contains an ethoxylate group of 5 to 12 ethylene oxide units.

In some embodiments, the surfactant is selected from the group consisting of ethoxylated fatty acids, ethoxylated fatty amines, and ethoxylated fatty amides wherein the fatty portion is a branched or linear, saturated or unsaturated aliphatic hydrocarbon moiety having from 6 to 18 carbon atoms.

In some embodiments, the surfactant is an alkoxylated castor oil. In some embodiments, the surfactant is a sorbitan ester derivative. In some embodiments the surfactant is an ethylene oxide-propylene oxide copolymer wherein the total number of EO and PO units is from 8 to 40 units. In some embodiments, the surfactant is an alkoxylated tristyryl phenol containing from 6 to 100 total ethylene oxide (EO) and propylene oxide (PO) units.

In some embodiments, the surfactant is an amine-based surfactant selected from the group consisting of ethoxylated alkylene amines, ethoxylated alkyl amines, propoxylated alkylene amines, propoxylated alkyl amines, ethoxylated-propoxylated alkylene amines and ethoxylated propoxylated alkyl amines. The ethoxylated/propoxylated alkylene or alkyl amine surfactant component preferably includes more than one nitrogen atom per molecule. Suitable amines include ethylenediaminealkoxylate and diethylenetriaminealkoxylate.

In some embodiments the surfactant is an alkoxylated polyimine with a relative solubility number (RSN) in the range of 5-20. As will be known to those of ordinary skill in the art, RSN values are generally determined by titrating water into a solution of surfactant in 1,4 dioxane. The RSN values is generally defined as the amount of distilled water necessary to be added to produce persistent turbidity. In some embodiments the surfactant is an alkoxylated novolac resin (also known as a phenolic resin) with a relative solubility number in the range of 5-20. In some embodiments the surfactant is a block copolymer surfactant with a total molecular weight greater than 5000 daltons. The block copolymer may have a hydrophobic block that is comprised of a polymer chain that is linear, branched, hyperbranched, dendritic or cyclic.

Glycosides and Glycamides

In some embodiments, the surfactant is an aliphatic polyglycoside having the following formula:

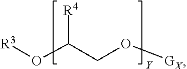

wherein R³ is an aliphatic group having from 6 to 18 carbon atoms; each R⁴ is independently selected from H, —CH₃, or —CH₂CH₃; Y is an average number of from about 0 to about 5; and X is an average degree of polymerization (DP) of from about 1 to about 4; G is the residue of a reducing saccharide, for example, a glucose residue. In some embodiments, Y is zero.

In some embodiments, the surfactant is an aliphatic glycamide having the following formula:

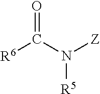

wherein R⁶ is an aliphatic group having from 6 to 18 carbon atoms; R⁵ is an alkyl group having from 1 to 6 carbon atoms; and Z is —CH₂(CH₂OH)_{b}CH₂OH, wherein b is from 3 to 5. In some embodiments, R⁵ is —CH₃. In some embodiments, R⁶ is an alkyl group having from 6 to 18 carbon atoms. In some embodiments, b is 3. In some embodiments, b is 4. In some embodiments, b is 5.

Anionic Surfactants

Suitable anionic surfactants include, but are not necessarily limited to, alkali metal alkyl sulfates, alkyl or alkylaryl sulfonates, linear or branched alkyl ether sulfates and sulfonates, alcohol polypropoxylated and/or polyethoxylated sulfates, alkyl or alkylaryl disulfonates, alkyl disulfates, alkyl sulphosuccinates, alkyl ether sulfates, linear and branched ether sulfates, fatty carboxylates, alkyl sarcosinates, alkyl phosphates and combinations thereof.

In some embodiments, the surfactant is an aliphatic sulfate wherein the aliphatic moiety is a branched or linear, saturated or unsaturated aliphatic hydrocarbon moiety having from 6 to 18 carbon atoms. In some embodiments, the surfactant is an aliphatic sulfonate wherein the aliphatic moiety is a branched or linear, saturated or unsaturated aliphatic hydrocarbon moiety having from 6 to 18 carbon atoms.

In some embodiments, the surfactant is an aliphatic alkoxy sulfate wherein the aliphatic moiety is a branched or linear, saturated or unsaturated aliphatic hydrocarbon moiety having from 6 to 18 carbon atoms and from 4 to 40 total ethylene oxide (EO) and propylene oxide (PO) units.

In some embodiments, the surfactant is an aliphatic-aromatic sulfate wherein the aliphatic moiety is a branched or linear, saturated or unsaturated aliphatic hydrocarbon moiety having from 6 to 18 carbon atoms. In some embodiments, the surfactant is an aliphatic-aromatic sulfonate wherein the aliphatic moiety is a branched or linear, saturated or unsaturated aliphatic hydrocarbon moiety having from 6 to 18 carbon atoms.

In some embodiments, the surfactant is an ester or half ester of sulfosuccinic acid with monohydric alcohols.

Cationic Surfactants

In some embodiments, the surfactant is a quaternary alkylammonium salt or a quaternary alkylbenzylammonium salt, whose alkyl groups have 1 to 24 carbon atoms (e.g., a halide, sulfate, phosphate, acetate, or hydroxide salt). In some embodiments, the surfactant is a quaternary alkylbenzylammonium salt, whose alkyl groups have 1-24 carbon atoms (e.g., a halide, sulfate, phosphate, acetate, or hydroxide salt). In some embodiments, the surfactant is an alkylpyridinium, an alkylimidazolinium, or an alkyloxazolinium salt whose alkyl chain has up to 18 carbons atoms (e.g., a halide, sulfate, phosphate, acetate, or hydroxide salt).

In some embodiments, the surfactant is a cationic surfactant such as, monoalkyl quaternary amines, such as cocotrimethylammonium chloride, cetyltrimethylammonium chloride, stearyltrimethylannnonium chloride, soyatrimethylannnonium chloride, behentrimethylammonium chloride, and the like and mixtures thereof. Other suitable cationic surfactants that may be useful include, but are not necessarily limited to, dialkylquaternary amines such as dicetyldimethylammonium chloride, dicocodimethylannnonium chloride, distearyldimethylammonium chloride, and the like and mixtures thereof.

Zwitterionic and Amphoteric Surfactants

In some embodiments, the surfactant is an amine oxide (e.g., dodecyldimethylamine oxide). In some embodiments, the surfactant is amphoteric or zwitterionic, including sultaines (e.g., cocamidopropyl hydroxysultaine), betaines (e.g., cocamidopropyl betaine), or phosphates (e.g., lecithin).

Organosilicone Surfactants

In some embodiments the surfactant comprises a mixture of a hydrophilic hydrocarbon surfactant and a hydrophilic organosilicone surfactant. Although the hydrophilic-lipophilic balance (HLB) system cannot strictly be applied to organosilicone surfactants, approximate HLB values for a hydrophilic organosilicone surfactant are from 8 to 18. In some embodiments, the hydrophilic organosilicone surfactant comprises one or more polyalkylene oxide groups containing from 4 to 40 total ethylene oxide (EO) and propylene oxide (PO) units. In some embodiments, the hydrophilic organosilicone surfactant comprises one or more polyethylene oxide groups containing from 4 to 12 ethylene oxide (EO) groups.

In some embodiments, the composition may comprise a single hydrophilic organosilicone surfactant or a combination of two or more hydrophilic organosilicone surfactants. For example, in some embodiments the hydrophilic organosilicone surfactant comprises a first type of hydrophilic organosilicone surfactant and a second type of hydrophilic organosilicone surfactant.

Non-limiting examples of hydrophilic organosilicone surfactants include polyalkyleneoxide-modified pentamethyldisiloxane, polyalkyleneoxide-modified heptamethyltrisiloxane, polyalkyleneoxide-modified nonamethyltetrasiloxane, polyalkyleneoxide-modified undecamethylpentasiloxane, polyalkyleneoxide-modified tridecamethylhexasiloxane and combinations thereof. The polyalkyleneoxide moiety may be end capped with —H, —CH₃, an acetoxy group, or an ethoxy group. The polyalkylene oxide group comprises polyethylene oxide, polypropyleneoxide, polybutyleneoxide, and combinations thereof.

In some embodiments the surfactant is an ethoxylated nonionic organosilicone surfactant. For example, the ethoxylated nonionic organosilicone surfactant may be a trisiloxane with an ethoxylate group having 4 to 12 ethylene oxide (EO) units. Non-limiting examples of such surfactants include trisiloxane surfactants having from 7 to 8 EO units, Momentive Silwet L-77®, Dow Corning Q2-5211 superwetting agent, and Dow Corning Q2-5212 wetting agent.

In some embodiments, the composition comprises a hydrophilic organosilicone surfactant. The composition may comprise a single hydrophilic organosilicone surfactant or a combination of two or more hydrophilic organosilicone surfactants. For example, in some embodiments the hydrophilic organosilicone surfactant comprises a first type of hydrophilic organosilicone surfactant and a second type of hydrophilic organosilicone surfactant. Non-limiting examples of hydrophilic organosilicone surfactants include but are not limited to polyalkyleneoxide-modified pentamethyldisiloxane, polyalkyleneoxide-modified heptamethyltrisiloxane, polyalkyleneoxide-modified nonamethyltetrasiloxane, polyalkyleneoxide-modified undecamethylpentasiloxane, polyalkyleneoxide-modified tridecamethylhexasiloxane, polyalkyleneoxide-modified polydimethylsiloxane and combinations thereof.

In some embodiments, the hydrophilic organosilicone surfactant comprises methoxy-modified polyalkylene pentamethyldisiloxane, methoxy-modified polyalkylene heptamethyltrisiloxane, methoxy-modified polyalkylene nonamethyltetrasiloxane, methoxy-modified polyalkylene undecamethylpentasiloxane, polyalkylene methoxy-modified tridecamethylhexasiloxane, methoxy-modified polyalkyleneoxide-modified polydimethylsiloxane, ethoxy-modified polyalkylene pentamethyldisiloxane, ethoxy-modified polyalkylene heptamethyltrisiloxane, ethoxy-modified polyalkylene nonamethyltetrasiloxane, ethoxy-modified polyalkylene undecamethylpentasiloxane, ethoxy-modified polyalkylene tridecamethylhexasiloxane, ethoxy-modified polyalkyleneoxide-modified polydimethylsiloxane and combinations thereof.

The polyalkyleneoxide moiety may be end capped with —H, —CH₃, an acetoxy group, or an ethoxy group. The polyalkylene oxide group comprises polyethylene oxide, polypropyleneoxide, polybutyleneoxide, and combinations thereof.

In some embodiments, the hydrophilic organosilicone surfactant comprises an ethoxylated nonionic organosilicone surfactant. In some embodiments, the ethoxylated nonionic organosilicone surfactant is a trisiloxane with an ethoxylate group having 4 to 12 ethylene oxide units.

In some embodiments the surfactant is an ethoxylated nonionic organosilicone surfactant. For example, the ethoxylated nonionic organosilicone surfactant may be a trisiloxane with an ethoxylate group having 4 to 12 ethylene oxide (EO) units. Non-limiting examples of such surfactants include trisiloxane surfactants having from 7 to 8 EO units, Momentive Silwet L-77®, Dow Corning Q2-5211 superwetting agent, and Dow Corning Q2-5212 wetting agent.

Non-limiting examples of suitable surfactants include nonionic surfactants with linear or branched structure, including, but not limited to, alkoxylated alcohols, alkoxylated fatty alcohols, alkoxylated castor oils, alkoxylated fatty acids, and alkoxylated fatty amides with a hydrocarbon chain of at least 8 carbon atoms and 5 units or more of alkoxylation. The term alkoxylation includes ethoxylation and propoxylation. Other nonionic surfactants include alkyl glycosides and alkyl glucamides. Additional surfactants are described herein. Other non-limiting examples of surfactants include adsorption modifiers, foamers, surface tension lowering enhancers, and emulsion breaking additives. Specific examples of such surfactants include cationic surfactants with a medium chain length, linear or branched anionic surfactants, alkyl benzene anionic surfactants, amine oxides, amphoteric surfactants, silicone based surfactants, alkoxylated novolac resins (e.g. alkoxylated phenolic resins), alkoxylated polyimines, alkoxylated polyamines, and fluorosurfactants. In some embodiments, the surfactant is a nonionic surfactant. In certain embodiments, the nonionic surfactant may be one or more of an ethoxylated castor oil, an ethoxylated alcohol, an ethoxylated tristyrylphenol, or an ethoxylated sorbitan ester, or combinations thereof.

Co-Solvent

In some embodiments, an emulsion or microemulsion further comprises a co-solvent. In some embodiments, the co-solvent is an alcohol. The co-solvent (e.g., alcohol) may serve as a coupling agent between the solvent and the surfactant and/or may aid in the stabilization of the emulsion or microemulsion. The alcohol may also be a freezing point depression agent for the emulsion or microemulsion. That is, the alcohol may lower the freezing point of the emulsion or microemulsion. In some embodiments, the alcohol is selected from primary, secondary, and tertiary alcohols having from 1 to 20 carbon atoms.

In some embodiments, the co-solvent is selected from the group consisting of methanol, ethanol, isopropanol, n-propanol, n-butanol, i-butanol, sec-butanol, iso-butanol, t-butanol, ethylene glycol, propylene glycol, dipropylene glycol monomethyl ether, triethylene glycol, and ethylene glycol monobutyl ether.

In some embodiments, the emulsion or microemulsion comprises from about 1 wt % to about 50 wt %, or from about 1 wt % to about 40 wt %, or from about 1 wt % to about 35 wt %, or from about 5 wt % to about 40 wt %, or from about 5 wt % to about 35 wt %, or from about 10 wt % to about 30 wt % of the co-solvent (e.g., alcohol), versus the total weight of the emulsion or microemulsion composition.

Additives

In some embodiments, the emulsion or microemulsion may comprise one or more additives in addition to the components discussed above. In some embodiments, the one or more additional additives are present in an amount from about 0 wt % to about 70 wt %, or from about 1 wt % to about 40 wt %, or from about 0 wt % to about 30 wt %, or from about 0.5 wt % to about 30 wt %, or from about 1 wt % to about 30 wt %, or from about 0 wt % to about 25 wt %, or from about 1 wt % to about 25 wt %, or from about 0 wt % to about 20 wt %, or from about 1 wt % to about 20 wt %, or from about 3 wt % to about 20 wt %, or from about 8 wt % to about 16 wt %, versus the total weight of the emulsion or microemulsion composition.

Non-limiting examples of additives include a demulsifier, a freezing point depression agent, a proppant, a scale inhibitor, a friction reducer, a biocide, a corrosion inhibitor, a buffer, a viscosifier, an oxygen scavenger, a clay control additive, a paraffin control additive, an asphaltene control additive, an acid, an acid precursor, or a salt.

In some embodiments, the additive is a demulsifier. The demulsifier may aid in preventing the formulation of an emulsion between a treatment fluid and crude oil. Non-limiting examples of demulsifiers include polyoxyethylene (50) sorbitol hexaoleate. In some embodiments, the demulsifier is present in the emulsion or microemulsion in an amount from about 4 wt % to about 8 wt % versus the total weight of the emulsion or microemulsion composition.

Freezing Point Depression Agent

In some embodiments, the emulsion or the microemulsion comprises a freezing point depression agent (e.g., propylene glycol). The emulsion or the microemulsion may comprise a single freezing point depression agent or a combination of two or more freezing point depression agents. The term “freezing point depression agent” is given its ordinary meaning in the art and refers to a compound which is added to a solution to reduce the freezing point of the solution. That is, in some embodiments, a solution comprising the freezing point depression agent has a lower freezing point as compared to an essentially identical solution not comprising the freezing point depression agent. Those of ordinary skill in the art will be aware of suitable freezing point depression agents for use in the emulsions or the microemulsions described herein. Non-limiting examples of freezing point depression agents include primary, secondary, and tertiary alcohols with from 1 to 20 carbon atoms and alkylene glycols. In some embodiments, the alcohol comprises at least 2 carbon atoms. Non-limiting examples of alcohols include methanol, ethanol, i-propanol, n-propanol, t-butanol, n-butanol, n-pentanol, n-hexanol, and 2-ethyl hexanol. In some embodiments, the freezing point depression agent is not methanol (e.g., due to toxicity). Non-limiting examples of alkylene glycols include ethylene glycol (EG), polyethylene glycol (PEG), propylene glycol (PG), and triethylene glycol (TEG). In some embodiments, the freezing point depression agent is not ethylene oxide (e.g., due to toxicity). In some embodiments, the freezing point depression agent comprises an alcohol and an alkylene glycol. In some embodiments, the freezing point depression agent comprises a carboxycyclic acid salt and/or a di-carboxycylic acid salt. Another non-limiting example of a freezing point depression agent is a combination of choline chloride and urea. In some embodiments, the emulsion or microemulsion comprising the freezing point depression agent is stable over a wide range of temperatures, e.g., from about 50° F. to 200° F. In some embodiments a freezing point depression agent is present in the emulsion or microemulsion in an amount from about 10 wt % to about 15 wt %.

Proppant

In some embodiments, the emulsion or the microemulsion comprises a proppant. In some embodiments, the proppant acts to hold induced hydraulic fractures open in an oil and/or gas well. Non-limiting examples of proppants (e.g., propping agents) include grains of sand, glass beads, crystalline silica (e.g., quartz), hexamethylenetetramine, ceramic proppants (e.g., calcined clays), resin coated sands, and resin coated ceramic proppants. Other proppants are also possible and will be known to those skilled in the art.

Scale Inhibitor

In some embodiments, the emulsion or the microemulsion comprises a scale inhibitor. The scale inhibitor may slow scaling in, e.g., the treatment of an oil and/or gas well, wherein scaling involves the unwanted deposition of solids (e.g., along a pipeline) that hinders fluid flow. Non-limiting examples of scale inhibitors include one or more of methyl alcohol, organic phosphonic acid salts (e.g., phosphonate salt, aminopolycarboxlic acid salts), polyacrylate, ethane-1,2-diol, calcium chloride, and sodium hydroxide. Other scale inhibitors are also possible and will be known to those skilled in the art.

Friction Reducer

In some embodiments, the emulsion or the microemulsion comprises a friction reducer. The friction reducer may reduce drag, which reduces energy input required in the context of e.g. delivering the emulsion or microemulsion into a wellbore. Non-limiting examples of friction reducers include oil-external emulsions of polymers with oil-based solvents and an emulsion-stabilizing surfactant. The emulsions may include natural-based polymers like guar, cellulose, xanthan, proteins, polypeptides or derivatives of same or synthetic polymers like polyacrylamide-co-acrylic acid (PAM-AA), polyethylene oxide, polyacrylic acid, and other copolymers of acrylamide and other vinyl monomers. For a list of non-limiting examples, see U.S. Pat. No. 8,865,632, filed Nov. 10, 2008, entitled “DRAG-REDUCING COPOLYMER COMPOSITION,” herein incorporated by reference. Other common drag-reducing additives include dispersions of natural- or synthetic polymers and copolymers in saline solution and dry natural- or synthetic polymers and copolymers. These polymers or copolymers may be nonionic, zwitterionic, anionic, or cationic depending on the composition of polymer and pH of solution. Other non-limiting examples of friction reducers include petroleum distillates, ammonium salts, polyethoxylated alcohol surfactants, and anionic polyacrylamide copolymers. Other friction reducers are also possible and will be known to those skilled in the art.

Biocide

In some embodiments, the emulsion or the microemulsion comprises a biocide. The biocide may kill unwanted organisms (e.g., microorganisms) that come into contact with the emulsion or microemulsion. Non-limiting examples of biocides include didecyl dimethyl ammonium chloride, gluteral, Dazomet, bronopol, tributyl tetradecyl phosphonium chloride, tetrakis (hydroxymethyl) phosphonium sulfate, AQUCAR®, UCARCIDE®, glutaraldehyde, sodium hypochlorite, and sodium hydroxide. Other biocides are also possible and will be known to those skilled in the art.

Corrosion Inhibitor

In some embodiments, the emulsion or the microemulsion comprises a corrosion inhibitor. The corrosion inhibitor may reduce corrosion during e.g. treatment of an oil and/or gas well (e.g., in a metal pipeline). Non-limiting examples of corrosion inhibitors include isopropanol, quaternary ammonium compounds, thiourea/formaldehyde copolymers, propargyl alcohol, and methanol. Other corrosion inhibitors are also possible and will be known to those skilled in the art.

Buffer

In some embodiments, the emulsion or the microemulsion comprises a buffer. The buffer may maintain the pH and/or reduce changes in the pH of the aqueous phase of the emulsion or the microemulsion. Non-limiting examples of buffers include acetic acid, acetic anhydride, potassium hydroxide, sodium hydroxide, and sodium acetate. Other buffers are also possible and will be known to those skilled in the art.

Viscosifier

In some embodiments, the emulsion or the microemulsion comprises a viscosifier. The viscosifier may increase the viscosity of the emulsion or the microemulsion. Non-limiting examples of viscosifiers include polymers, e.g., guar, cellulose, xanthan, proteins, polypeptides or derivatives of same or synthetic polymers like polyacrylamide-co-acrylic acid (PAM-AA), polyethylene oxide, polyacrylic acid, and other copolymers of acrylamide and other vinyl monomers. Other viscosifiers are also possible and will be known to those skilled in the art.

Oxygen Scavenger

In some embodiments, the emulsion or the microemulsion comprises an oxygen scavenger. The oxygen scavenger may decrease the level of oxygen in the emulsion or the microemulsion. Non-limiting examples of oxygen scavengers include sulfites and bisulfites. Other oxygen scavengers are also possible and will be known to those skilled in the art.

Clay Control Additive

In some embodiments, the emulsion or the microemulsion comprises a clay control additive. The clay control additive may minimize damaging effects of clay (e.g., swelling, migration), e.g., during treatment of oil and/or gas wells. Non-limiting examples of clay control additives include quaternary ammonium chloride, tetramethylammonium chloride, polymers (e.g., polyanionic cellulose (PAC), partially hydrolyzed polyacrylamide (PHPA), etc.), glycols, sulfonated asphalt, lignite, sodium silicate, and choline chloride. Other clay control additives are also possible and will be known to those skilled in the art.

Paraffin Control Additive and/or Asphaltene Control Additive

In some embodiments, the emulsion or the microemulsion comprises a paraffin control additive and/or an asphaltene control additive. The paraffin control additive or the asphaltene control additive may minimize paraffin deposition or asphaltene precipitation respectively in crude oil, e.g., during treatment of oil and/or gas wells. Non-limiting examples of paraffin control additives and asphaltene control additives include active acidic copolymers, active alkylated polyester, active alkylated polyester amides, active alkylated polyester imides, aromatic naphthas, and active amine sulfonates. Other paraffin control additives and asphaltene control additives are also possible and will be known to those skilled in the art.

Acid and/or Acid Precursor

In some embodiments, the emulsion or the microemulsion comprises an acid and/or an acid precursor (e.g., an ester). For example, the emulsion or the microemulsion may comprise an acid when used during acidizing operations. In some embodiments, the surfactant is alkaline and an acid (e.g., hydrochloric acid) may be used to adjust the pH of the emulsion or the microemulsion towards neutral. Non-limiting examples of acids or di-acids include hydrochloric acid, acetic acid, formic acid, succinic acid, maleic acid, malic acid, lactic acid, and hydrochloric-hydrofluoric acids. In some embodiments, the emulsion or the microemulsion comprises an organic acid or organic di-acid in the ester (or di-ester) form, whereby the ester (or diester) is hydrolyzed in the wellbore and/or reservoir to form the parent organic acid and an alcohol in the wellbore and/or reservoir. Non-limiting examples of esters or di-esters include isomers of methyl formate, ethyl formate, ethylene glycol diformate, alpha,alpha-4-trimethyl-3-cyclohexene-1-methylformate, methyl lactate, ethyl lactate, alpha,alpha-4-trimethyl 3-cyclohexene-1-methyllactate, ethylene glycol dilactate, ethylene glycol diacetate, methyl acetate, ethyl acetate, alpha,alpha,-4-trimethyl-3-cyclohexene-1-methylacetate, dimethyl succinate, dimethyl maleate, di(alpha,alpha-4-trimethyl-3-cyclohexene-1-methyl)-succinate, 1-methyl-4-(1-methylethenyl)-cyclohexylformate, 1-methyl-4-(1-ethylethenyl)-cyclohexylactate, 1-methyl-4-(1-methylethenyl)-cyclohexylacetate, and di(1-methy-4-(1-methylethenyl)cyclohexyl)-succinate. Other acids are also possible and will be known to those skilled in the art.

Salt

In some embodiments, the emulsion or the microemulsion comprises a salt. The salt may reduce the amount of water needed as a carrier fluid and/or may lower the freezing point of the emulsion or the microemulsion. Non limiting examples of salts include salts comprising K, Na, Br, Cr, Cs, or Li, e.g., halides of these metals, including but not limited to NaCl, KCl, CaCl₂, and MgCl₂. Other salts are also possible and will be known to those skilled in the art.

In some embodiments, the emulsion or the microemulsion comprises an additive as described in U.S. patent application Ser. No. 15/457,792, filed Mar. 13, 2017, entitled “METHODS AND COMPOSITIONS INCORPORATING ALKYL POLYGLYCOSIDE SURFACTANT FOR USE IN OIL AND/OR GAS WELLS,” herein incorporated by reference.

The emulsions or microemulsions described herein may be formed using methods known to those of ordinary skill in the art. In some embodiments, the aqueous and non-aqueous phases may be combined (e.g., the water and the solvent(s)), followed by addition of a surfactant(s) and optionally a co-solvent(s) (e.g., alcohol(s)) and agitation). The strength, type, and length of the agitation may be varied as known in the art depending on various factors including the components of the emulsion or microemulsion, the quantity of the emulsion or microemulsion, and the resulting type of emulsion or microemulsion formed. For example, for small samples, a few seconds of gentle mixing can yield an emulsion or microemulsion, whereas for larger samples, longer agitation times and/or stronger agitation may be required. Agitation may be provided by any suitable source, e.g., a vortex mixer, a stirrer (e.g., magnetic stirrer), etc.

Any suitable method for injecting the emulsion or microemulsion (e.g., a diluted emulsion or microemulsion) into a wellbore may be employed. For example, in some embodiments, the emulsion or microemulsion, optionally diluted, may be injected into a subterranean formation by injecting it into a well or wellbore in the zone of interest of the formation and thereafter pressurizing it into the formation for the selected distance. Methods for achieving the placement of a selected quantity of a mixture in a subterranean formation are known in the art. The well may be treated with the emulsion or microemulsion for a suitable period of time. The emulsion or microemulsion and/or other fluids may be removed from the well using known techniques, including producing the well.

It should be understood, that in embodiments where an emulsion or microemulsion is said to be injected into a wellbore, that the emulsion or microemulsion may be diluted and/or combined with other liquid component(s) prior to and/or during injection (e.g., via straight tubing, via coiled tubing, etc.). For example, in some embodiments, the emulsion or microemulsion is diluted with an aqueous carrier fluid (e.g., water, brine, sea water, fresh water, or a well-treatment fluid (e.g., an acid, a fracturing fluid comprising polymers, produced water, sand, slickwater, etc.,)) prior to and/or during injection into the wellbore. In some embodiments, a composition for injecting into a wellbore is provided comprising an emulsion or microemulsion as described herein and an aqueous carrier fluid, wherein the emulsion or microemulsion is present in an amount from about 0.1 gallons per thousand gallons (gpt) per dilution fluid to about 50 gpt, or from about 0.1 gpt to about 100 gpt, or from about 0.5 gpt to about 10 gpt, or from about 0.5 gpt to about 2 gpt.

The emulsions and microemulsions described herein may be used in various aspects (e.g. steps) of the life cycle of an oil and/or gas well, including, but not limited to, drilling, mud displacement, casing, cementing, perforating, stimulation, kill fluids, enhanced oil recovery, improved oil recovery, stored fluid, and offshore applications. Inclusion of an emulsion or microemulsion into the fluids typically employed in these processes, e.g., drilling fluids, mud displacement fluids, casing fluids, cementing fluids, perforating fluid, stimulation fluids, kill fluids, etc., may result in many advantages as compared to use of the fluid alone.

Various aspects of the well life cycle are described in detail in U.S. patent application Ser. No. 14/212,731, filed Mar. 14, 2014, entitled “METHODS AND COMPOSITIONS FOR USE IN OIL AND/OR GAS WELLS,” now published as US/2014/0284053 on Sep. 25, 2014 and in U.S. patent application Ser. No. 14/212,763, filed Mar. 14, 2014, entitled “METHODS AND COMPOSITIONS FOR USE IN OIL AND/OR GAS WELLS,” now published as US/2014/0338911 on Nov. 20, 2014, each herein incorporated by reference.

As will be understood by those of ordinary skill in the art, the steps of the life cycle of an oil and/or gas well may be carried out in a variety of orders. In addition, in some embodiments, each step may occur more than once in the life cycle of the well.

In some embodiments, the compositions described herein are used in methods to treat an oil and/or gas well having a wellbore, wherein the methods may comprise reducing residues (e.g., wash-off of residues) on or near a wellbore. In some embodiments, the residues comprise kerogens, asphaltenes, paraffins, organic scale, or combinations thereof on or near the wellbore. In some embodiments, the emulsion or microemulsion composition may be diluted prior to use (e.g., diluted using 2% KCl by weight of water). In some embodiments, the dilution of the emulsion or microemulsion composition is to 2 gallons per thousand gallons.

Wash-Off of Asphaltene and/or Paraffin Residues Using a Microfluidic Device

In some embodiments, the degree to which wash-off of asphaltene and/or paraffin residues may be determined using a microfluidic device. For example, the diluted emulsion or microemulsion composition may be made to flow through a microfluidic device comprising posts from 100 microns to 150 microns in diameter (e.g., 125 microns) and spaced apart vertically by from 80 microns to 140 microns (e.g., 110 microns) and spaced apart horizontally by from 300 microns to 400 microns (e.g., 350 microns), onto and around which posts asphaltene and/or paraffin residues have been deposited. The flow rate of the diluted emulsion or microemulsion composition through the microfluidic device may be from about 30 microliters/minute to about 90 microliters/min (e.g., 60 microliters/minute). The duration of flow of the diluted emulsion or microemulsion composition through the microfluidic device may be at least 30 minutes and at most 180 minutes (e.g., 120 minutes). The reduction in the residues may be determined by comparing at least two images of a microfluidic device. In some embodiments, each image is obtained at a different time point. For example, the first image may be obtained prior to the solution flowing and/or immediately following the start of the flow (e.g., time point zero). In some embodiments, a second image is obtained following flow of the diluted emulsion or microemulsion composition through the microfluidic device for a specified period of time. A measure of reduction of residues may in some embodiments be determined by image analysis of the at least two images. In some embodiments, image analysis may comprise converting the images to grayscale. In some embodiments, image analysis further comprises using e.g. a thresholding technique to differentiate the asphaltene and/or paraffin residues from the device. Image analysis in some embodiments comprises calculating the area of asphaltene and/or paraffin residues present in the microfluidic device, for each duration of flow of the diluted emulsion or microemulsion composition, and calculating the difference between the two to determine the percent wash-off (e.g., reduction) of asphaltene and/or paraffin residues. In some embodiments, the percent wash-off for the emulsion or microemulsion composition may be up to 100% for a duration of flow of up to 120 minutes at a flow rate of 60 microliters/min.

In some embodiments, the percent reduction of asphaltene and/or paraffin residues using an emulsion or microemulsion comprising a terpene and an aromatic ester solvent is compared with the percent wash-off using a substantially similar emulsion or microemulsion comprising only the terpene. In some embodiments, the percent wash-off for the emulsion or microemulsion composition having an aqueous phase comprising a solvent blend of an aromatic ester solvent and a terpene may be at least about 5% greater, or at least about 10% greater, or at least about 20% greater, or at least about 40% greater, or at least about 80% greater, or at least about 100% greater, or at least about 200% greater, or at least about 300% greater, or at least about 400% greater, or at least about 500% greater, as compared to the percent wash-off obtained under substantially similar conditions using a substantially similar emulsion or microemulsion only comprising the terpene as the non-aqueous phase. In some embodiments, the percent wash-off for the emulsion or microemulsion composition having an aqueous phase comprising a solvent blend of an aromatic ester solvent and a terpene may be at most about 600% greater, or at most about 500% greater, at most about 400% greater, or at most about 300% greater, or at most about 200% greater, or at most about 100% greater, or at most about 80% greater, or at most about 40% greater, or at most about 20% greater, or at most about 10% greater, as compared to the percent wash-off obtained under substantially similar conditions using a substantially similar emulsion or microemulsion only comprising the terpene as the non-aqueous phase.

In some embodiments, the percent wash-off for the emulsion or microemulsion composition may vary unexpectedly with the weight ratio of the first type of solvent (e.g., a terpene) and the second type of solvent (e.g., an aromatic ester solvent) in the non-aqueous solvent blend present in the emulsion or microemulsion composition. For example, the percent asphaltene wash-off at 13.5 minutes duration of flow of a microemulsion comprising d-limonene and benzyl benzoate in a weight ratio of 70:30 may be about 1%, whereas the percent asphaltene wash-off at 13.5 minutes duration of flow of a microemulsion comprising d-limonene and benzyl benzoate in a weight ratio of 60:40 may be about 10% (See e.g., Example 1).

It was surprising to see that the asphaltene residue reduction performance of diluted microemulsions comprising aromatic ester solvents and a terpene approached that of neat d-limonene in microfluidics wash-off tests (See e.g., Example 1 and Example 2). This result is surprising, in part, because the asphaltene residue reduction performance of a microemulsion comprising neat aromatic ester solvent as the non-aqueous phase had reduced performance as compared to a substantially similar composition but including neat d-limonene as the non-aqueous phase. In addition, emulsions or microemulsions comprising aromatic ester solvents may also be used in remediation/restimulation applications and have better performance than existing emulsion or microemulsion compositions comprising only terpenes.

As used herein, the term emulsion is given its ordinary meaning in the art and refers to dispersions of one immiscible liquid in another, in the form of droplets, with diameters approximately in the range of 100-1,000 nanometers. Emulsions may be thermodynamically unstable and/or require high shear forces to induce their formation.

As used herein, the term microemulsion is given its ordinary meaning in the art and refers to dispersions of one immiscible liquid in another, in the form of droplets, with diameters approximately in the range of about from about 1 nanometers (nm) to about 1000 nm, or from about 10 nm to about 1000 nm, or from about 10 nm to about 500 nm, or from about 10 nm to about 300 nm, or from about 10 nm to about 100 nm.

In some embodiments, microemulsions are clear or transparent because they contain particles smaller than the wavelength of visible light. In addition, microemulsions are homogeneous thermodynamically stable single phases, and form spontaneously, and thus, differ markedly from thermodynamically unstable emulsions, which generally depend upon intense mixing energy for their formation. Microemulsions may be characterized by a variety of advantageous properties including, by not limited to, (i) clarity, (ii) very small particle size, (iii) ultra-low interfacial tensions, (iv) the ability to combine properties of water and oil in a single homogeneous fluid, (v) shelf life stability, and (vi) ease of preparation.

In some embodiments, the microemulsions described herein are stabilized microemulsions that are formed by the combination of a solvent-surfactant blend with an appropriate oil-based or water-based carrier fluid. Generally, the microemulsion forms upon simple mixing of the components without the need for high shearing generally required in the formation of ordinary emulsions. In some embodiments, the microemulsion is a thermodynamically stable system, and the droplets remain finely dispersed over time. In some embodiments, the average droplet size ranges from about 10 nm to about 300 nm.

It should be understood that the description herein which focuses on microemulsions is by no means limiting, and emulsions may be employed where appropriate.

In some embodiments, the emulsion or microemulsion is a single emulsion or microemulsion. For example, the emulsion or microemulsion comprises a single layer of a surfactant. In other embodiments, the emulsion or microemulsion may be a double or multilamellar emulsion or microemulsion. For example, the emulsion or microemulsion comprises two or more layers of a surfactant. In some embodiments, the emulsion or microemulsion comprises a single layer of surfactant surrounding a core (e.g., one or more of water, oil, solvent, and/or other additives) or a multiple layers of surfactant (e.g., two or more concentric layers surrounding the core). In certain embodiments, the emulsion or microemulsion comprises two or more immiscible cores (e.g., one or more of water, oil, solvent, and/or other additives which have equal or about equal affinities for the surfactant).

For convenience, certain terms employed in the specification, examples, and appended claims are listed here.

The term “emulsion” is given its ordinary meaning in the art and generally refers to a thermodynamically stable dispersion of water-in-oil or oil-in-water wherein in some embodiments (e.g., in the case of a macroemulsion) the interior phase is in the form of visually discernable droplets and the overall emulsion is cloudy, and wherein the droplet diameter may in some embodiments (e.g., in the case of a macroemulsion) be greater than about 300 nm.

The term “microemulsion” is given its ordinary meaning in the art and generally refers to a thermodynamically stable dispersion of water and oil that forms spontaneously upon mixture of oil, water and various surfactants. Microemulsion droplets generally have a mean diameter of less than 300 nm. Because microemulsion droplets are smaller than the wavelength of visible light, solutions comprising them are generally translucent or transparent, unless there are other components present that interfere with passage of visible light. In some embodiments, a microemulsion is substantially homogeneous. In other embodiments, microemulsion particles may co-exist with other surfactant-mediated systems, e.g., micelles, hydrosols, and/or macroemulsions. In some embodiments, the microemulsions of the present invention are oil-in-water microemulsions. In some embodiments, the majority of the oil component, e.g., (in various embodiments, greater than about 50%, greater than about 75%, or greater than about 90%), is located in microemulsion droplets rather than in micelles or macroemulsion droplets. In various embodiments, the microemulsions of the invention are clear or substantially clear.

The conventional terms water-in-oil and oil-in-water, whether referring to macroemulsions, emulsions, or microemulsions, simply describe systems that are water-discontinuous and water-continuous, respectively. They do not denote any additional restrictions on the range of substances denoted as “oil”.

The terms “clear” or “transparent” as applied to a microemulsion are given its ordinary meaning in the art and generally refers to the microemulsion appearing as a single phase without any particulate or colloidal material or a second phase being present when viewed by the naked eye.

The terms “substantially insoluble” or “insoluble” is given its ordinary meaning in the art and generally refers to embodiments wherein the solubility of the compound in a liquid is zero or negligible. In connection with the compositions described herein, the solubility of the compound may be insufficient to make the compound practicably usable in an agricultural end use without some modification either to increase its solubility or dispersability in the liquid (e.g., water), so as to increase the compound's bioavailability or avoid the use of excessively large volumes of solvent.

Definitions of specific functional groups and chemical terms are described in more detail below. For purposes of this invention, the chemical elements are identified in accordance with the Periodic Table of the Elements, CAS version, Handbook of Chemistry and Physics, 75^{th} Ed., inside cover, and specific functional groups are generally defined as described therein. Additionally, general principles of organic chemistry, as well as specific functional moieties and reactivity, are described in Organic Chemistry, Thomas Sorrell, University Science Books, Sausalito: 1999, the entire contents of which are incorporated herein by reference.

Certain compounds of the present invention may exist in particular geometric or stereoisomeric forms. The present invention contemplates all such compounds, including cis- and trans-isomers, R- and S-enantiomers, diastereomers, (D)-isomers, (L)-isomers, the racemic mixtures thereof, and other mixtures thereof, as falling within the scope of the invention. Additional asymmetric carbon atoms may be present in a substituent such as an alkyl group. All such isomers, as well as mixtures thereof, are intended to be included in this invention.

Isomeric mixtures containing any of a variety of isomer ratios may be utilized in accordance with the present invention. For example, where only two isomers are combined, mixtures containing 50:50, 60:40, 70:30, 80:20, 90:10, 95:5, 96:4, 97:3, 98:2, 99:1, or 100:0 isomer ratios are all contemplated by the present invention. Those of ordinary skill in the art will readily appreciate that analogous ratios are contemplated for more complex isomer mixtures.

The term “aliphatic,” as used herein, includes both saturated and unsaturated, nonaromatic, straight chain (i.e., unbranched), branched, acyclic, and cyclic (i.e., carbocyclic) hydrocarbons, which are optionally substituted with one or more functional groups. As will be appreciated by one of ordinary skill in the art, “aliphatic” is intended herein to include, but is not limited to, alkyl, alkenyl, alkynyl, cycloalkyl, cycloalkenyl, and cycloalkynyl moieties. Thus, as used herein, the term “alkyl” includes straight, branched and cyclic alkyl groups. An analogous convention applies to other generic terms such as “alkenyl”, “alkynyl”, and the like. Furthermore, as used herein, the terms “alkyl”, “alkenyl”, “alkynyl”, and the like encompass both substituted and unsubstituted groups. In certain embodiments, as used herein, “aliphatic” is used to indicate those aliphatic groups (cyclic, acyclic, substituted, unsubstituted, branched or unbranched) having 1 to 20 carbon atoms. Aliphatic group substituents include, but are not limited to, any of the substituents described herein, that result in the formation of a stable moiety (e.g., aliphatic, alkyl, alkenyl, alkynyl, heteroaliphatic, heterocyclic, aryl, heteroaryl, acyl, oxo, imino, thiooxo, cyano, isocyano, amino, azido, nitro, hydroxyl, thiol, halo, aliphaticamino, heteroaliphaticamino, alkylamino, heteroalkylamino, arylamino, heteroarylamino, alkylaryl, arylalkyl, aliphaticoxy, heteroaliphaticoxy, alkyloxy, heteroalkyloxy, aryloxy, heteroaryloxy, aliphaticthioxy, heteroaliphaticthioxy, alkylthioxy, heteroalkylthioxy, arylthioxy, heteroarylthioxy, acyloxy, and the like, each of which may or may not be further substituted).

As used herein, the term “alkyl” is given its ordinary meaning in the art and refers to the radical of saturated aliphatic groups, including straight chain alkyl groups, branched-chain alkyl groups, cycloalkyl (alicyclic) groups, alkyl substituted cycloalkyl groups, and cycloalkyl substituted alkyl groups. In some embodiments, the alkyl group may be a lower alkyl group, e.g., an alkyl group having 1 to 10 carbon atoms (e.g., methyl, ethyl, propyl, butyl, pentyl, hexyl, heptyl, octyl, nonyl, or decyl). In some embodiments, a straight chain or branched chain alkyl may have 30 or fewer carbon atoms in its backbone, and, in some embodiments, 20 or fewer. In some embodiments, a straight chain or branched chain alkyl may have 12 or fewer carbon atoms in its backbone (e.g., C₁-C₁₂ for straight chain, C₃-C₁₂ for branched chain), 6 or fewer, or 4 or fewer. Likewise, cycloalkyls may have from 3 to 10 carbon atoms in their ring structure, or 5, 6 or 7 carbon atoms in their ring structure. Examples of alkyl groups include, but are not limited to, methyl, ethyl, propyl, isopropyl, cyclopropyl, butyl, isobutyl, t-butyl, cyclobutyl, hexyl, and cyclochexyl.

The term “heteroalkyl” is given its ordinary meaning in the art and refers to an alkyl group as described herein in which one or more carbon atoms is replaced by a heteroatom. Suitable heteroatoms include oxygen, sulfur, nitrogen, phosphorus, and the like. Examples of heteroalkyl groups include, but are not limited to, alkoxy, alkoxyalkyl, amino, thioester, poly(ethylene glycol), and alkyl-substituted amino.

The terms “alkenyl” and “alkynyl” are given their ordinary meaning in the art and refer to unsaturated aliphatic groups analogous in length and possible substitution to the alkyls described above, but that contain at least one double or triple bond respectively.

In certain embodiments, the alkyl, alkenyl and alkynyl groups employed in the invention contain 1 to 20 aliphatic carbon atoms. In certain other embodiments, the alkyl, alkenyl, and alkynyl groups employed in the invention contain 1 to 10 aliphatic carbon atoms. In yet other embodiments, the alkyl, alkenyl, and alkynyl groups employed in the invention contain 1 to 8 aliphatic carbon atoms. In still other embodiments, the alkyl, alkenyl, and alkynyl groups employed in the invention contain 1 to 6 aliphatic carbon atoms. In yet other embodiments, the alkyl, alkenyl, and alkynyl groups employed in the invention contain 1 to 4 carbon atoms. Illustrative aliphatic groups thus include, but are not limited to, for example, methyl, ethyl, n-propyl, isopropyl, allyl, n-butyl, sec-butyl, isobutyl, t-butyl, n-pentyl, sec-pentyl, isopentyl, t-pentyl, n-hexyl, sec-hexyl, moieties and the like, which again, may bear one or more substituents. Alkenyl groups include, but are not limited to, for example, ethenyl, propenyl, butenyl, 1-methyl-2-buten-1-yl, and the like. Representative alkynyl groups include, but are not limited to, ethynyl, 2-propynyl (propargyl), 1-propynyl and the like.

The term “cycloalkyl,” as used herein, refers specifically to groups having three to ten, preferably three to seven carbon atoms. Suitable cycloalkyls include, but are not limited to cyclopropyl, cyclobutyl, cyclopentyl, cyclohexyl, cycloheptyl and the like, which, as in the case of other aliphatic, heteroaliphatic, or hetercyclic moieties, may optionally be substituted with substituents including, but not limited to aliphatic; heteroaliphatic; aryl; heteroaryl; arylalkyl; heteroarylalkyl; alkoxy; aryloxy; heteroalkoxy; heteroaryloxy; alkylthio; arylthio; heteroalkylthio; heteroarylthio; —F; —Cl; —Br; —I; —OH; —NO₂; —CN; —CF₃; —CH₂CF₃; —CHCl₂; —CH₂OH; —CH₂CH₂OH; —CH₂NH₂; —CH₂SO₂CH₃; —C(O)R^{x}; —CO₂(R^{x}); —CON(R^{x})₂; —OC(O)R^{x}; —OCO₂R^{x}; —OCON(R^{x})₂; —N(R^{x})₂; —S(O)₂R^{x}; —NR^{x}(CO)R^{x}, wherein each occurrence of R^{x} independently includes, but is not limited to, aliphatic, heteroaliphatic, aryl, heteroaryl, arylalkyl, or heteroarylalkyl, wherein any of the aliphatic, heteroaliphatic, arylalkyl, or heteroarylalkyl substituents described above and herein may be substituted or unsubstituted, branched or unbranched, cyclic or acyclic, and wherein any of the aryl or heteroaryl substituents described above and herein may be substituted or unsubstituted. Additional examples of generally applicable substituents are illustrated by the specific embodiments shown in the examples that are described herein.

The term “heteroaliphatic,” as used herein, refers to an aliphatic moiety, as defined herein, which includes both saturated and unsaturated, nonaromatic, straight chain (i.e., unbranched), branched, acyclic, cyclic (i.e., heterocyclic), or polycyclic hydrocarbons, which are optionally substituted with one or more functional groups, and that contain one or more oxygen, sulfur, nitrogen, phosphorus, or silicon atoms, e.g., in place of carbon atoms. In certain embodiments, heteroaliphatic moieties are substituted by independent replacement of one or more of the hydrogen atoms thereon with one or more substituents. As will be appreciated by one of ordinary skill in the art, “heteroaliphatic” is intended herein to include, but is not limited to, heteroalkyl, heteroalkenyl, heteroalkynyl, heterocycloalkyl, heterocycloalkenyl, and heterocycloalkynyl moieties. Thus, the term “heteroaliphatic” includes the terms “heteroalkyl,” “heteroalkenyl”, “heteroalkynyl”, and the like. Furthermore, as used herein, the terms “heteroalkyl”, “heteroalkenyl”, “heteroalkynyl”, and the like encompass both substituted and unsubstituted groups. In certain embodiments, as used herein, “heteroaliphatic” is used to indicate those heteroaliphatic groups (cyclic, acyclic, substituted, unsubstituted, branched or unbranched) having 1 to 20 carbon atoms. Heteroaliphatic group substituents include, but are not limited to, any of the substituents described herein, that result in the formation of a stable moiety (e.g., aliphatic, alkyl, alkenyl, alkynyl, heteroaliphatic, heterocyclic, aryl, heteroaryl, acyl, sulfinyl, sulfonyl, oxo, imino, thiooxo, cyano, isocyano, amino, azido, nitro, hydroxyl, thiol, halo, aliphaticamino, heteroaliphaticamino, alkylamino, heteroalkylamino, arylamino, heteroarylamino, alkylaryl, arylalkyl, aliphaticoxy, heteroaliphaticoxy, alkyloxy, heteroalkyloxy, aryloxy, heteroaryloxy, aliphaticthioxy, heteroaliphaticthioxy, alkylthioxy, heteroalkylthioxy, arylthioxy, heteroarylthioxy, acyloxy, and the like, each of which may or may not be further substituted).

The terms “heteroalkenyl” and “heteroalkynyl” are given their ordinary meaning in the art and refer to unsaturated aliphatic groups analogous in length and possible substitution to the heteroalkyls described above, but that contain at least one double or triple bond respectively.

Some examples of substituents of the above-described aliphatic (and other) moieties of compounds of the invention include, but are not limited to aliphatic; heteroaliphatic; aryl; heteroaryl; alkylaryl; alkylheteroaryl; alkoxy; aryloxy; heteroalkoxy; heteroaryloxy; alkylthio; arylthio; heteroalkylthio; heteroarylthio; F; Cl; Br; I; —OH; —NO₂; —CN; —CF₃; —CHF₂; —CH₂F; —CH₂CF₃; —CHCl₂; —CH₂OH; —CH₂CH₂OH; —CH₂NH₂; —CH₂SO₂CH₃; —C(O)R^{x}; —CO₂(R^{x}); —CON(R^{x})₂; —OC(O)R^{x}; —OCO₂R^{x}; —OCON(R^{x})₂; —N(R^{x})₂; —S(O)₂R^{x}; —NR^{x}(CO)R^{x} wherein each occurrence of R^{x} independently includes, but is not limited to, aliphatic, alycyclic, heteroaliphatic, heterocyclic, aryl, heteroaryl, alkylaryl, or alkylheteroaryl, wherein any of the aliphatic, heteroaliphatic, alkylaryl, or alkylheteroaryl substituents described above and herein may be substituted or unsubstituted, branched or unbranched, cyclic or acyclic, and wherein any of the aryl or heteroaryl substituents described above and herein may be substituted or unsubstituted. Additional examples of generally applicable substituents are illustrated by the specific embodiments shown in the Examples that are described herein.

As used herein, the term “aromatic” is given its ordinary meaning in the art and refers to aromatic carbocyclic groups, having a single ring (e.g., phenyl), multiple rings (e.g., biphenyl), or multiple fused rings in which at least one is aromatic (e.g., 1,2,3,4-tetrahydronaphthyl, naphthyl, anthryl, or phenanthryl). That is, at least one ring may have a conjugated pi electron system, while other, adjoining rings can be cycloalkyls, cycloalkenyls, cycloalkynyls, aryls and/or heterocyclyls.

As used herein, the term “aryl” is given its ordinary meaning in the art and refers to aromatic carbocyclic groups, optionally substituted, having a single ring (e.g., phenyl), multiple rings (e.g., biphenyl), or multiple fused rings in which at least one is aromatic (e.g., 1,2,3,4-tetrahydronaphthyl, naphthyl, anthryl, or phenanthryl). That is, at least one ring may have a conjugated pi electron system, while other, adjoining rings can be cycloalkyls, cycloalkenyls, cycloalkynyls, aryls and/or heterocyclyls. The aryl group may be optionally substituted, as described herein. Substituents include, but are not limited to, any of the previously mentioned substituents, e.g., the substituents recited for aliphatic moieties, or for other moieties as disclosed herein, resulting in the formation of a stable compound. In some embodiments, an aryl group is a stable monocyclic or polycyclic unsaturated moiety having preferably 3 to 14 carbon atoms, each of which may be substituted or unsubstituted.

The term “heterocycle” is given its ordinary meaning in the art and refers to cyclic groups containing at least one heteroatom as a ring atom, in some embodiments, 1 to 3 heteroatoms as ring atoms, with the remainder of the ring atoms being carbon atoms. Suitable heteroatoms include oxygen, sulfur, nitrogen, phosphorus, and the like. In some embodiments, the heterocycle may be 3-membered to 10-membered ring structures or 3-membered to 7-membered rings, whose ring structures include one to four heteroatoms.

The term “heterocycle” may include heteroaryl groups, saturated heterocycles (e.g., cycloheteroalkyl) groups, or combinations thereof. The heterocycle may be a saturated molecule, or may comprise one or more double bonds. In some embodiments, the heterocycle is a nitrogen heterocycle, wherein at least one ring comprises at least one nitrogen ring atom. The heterocycles may be fused to other rings to form a polycylic heterocycle. The heterocycle may also be fused to a spirocyclic group. In some embodiments, the heterocycle may be attached to a compound via a nitrogen or a carbon atom in the ring.

Heterocycles include, e.g., thiophene, benzothiophene, thianthrene, furan, tetrahydrofuran, pyran, isobenzofuran, chromene, xanthene, phenoxathiin, pyrrole, dihydropyrrole, pyrrolidine, imidazole, pyrazole, pyrazine, isothiazole, isoxazole, pyridine, pyrazine, pyrimidine, pyridazine, indolizine, isoindole, indole, indazole, purine, quinolizine, isoquinoline, quinoline, phthalazine, naphthyridine, quinoxaline, quinazoline, cinnoline, pteridine, carbazole, carboline, triazole, tetrazole, oxazole, isoxazole, thiazole, isothiazole, phenanthridine, acridine, pyrimidine, phenanthroline, phenazine, phenarsazine, phenothiazine, furazan, phenoxazine, pyrrolidine, oxolane, thiolane, oxazole, oxazine, piperidine, homopiperidine (hexamnethyleneimine), piperazine (e.g., N-methyl piperazine), morpholine, lactones, lactams such as azetidinones and pyrrolidinones, sultams, sultones, other saturated and/or unsaturated derivatives thereof, and the like. The heterocyclic ring can be optionally substituted at one or more positions with such substituents as described herein. In some embodiments, the heterocycle may be bonded to a compound via a heteroatom ring atom (e.g., nitrogen). In some embodiments, the heterocycle may be bonded to a compound via a carbon ring atom. In some embodiments, the heterocycle is pyridine, imidazole, pyrazine, pyrimidine, pyridazine, acridine, acridin-9-amine, bipyridine, naphthyridine, quinoline, benzoquinoline, benzoisoquinoline, phenanthridine-1,9-diamine, or the like.

The term “heteroaryl” is given its ordinary meaning in the art and refers to aryl groups comprising at least one heteroatom as a ring atom. A “heteroaryl” is a stable heterocyclic or polyheterocyclic unsaturated moiety having preferably 3 to 14 carbon atoms, each of which may be substituted or unsubstituted. Substituents include, but are not limited to, any of the previously mentioned substituents, e.g., the substituents recited for aliphatic moieties, or for other moieties as disclosed herein, resulting in the formation of a stable compound. In some embodiments, a heteroaryl is a cyclic aromatic radical having from five to ten ring atoms of which one ring atom is selected from S, O, and N; zero, one, or two ring atoms are additional heteroatoms independently selected from S, O, and N; and the remaining ring atoms are carbon, the radical being joined to the rest of the molecule via any of the ring atoms, such as, e.g., pyridyl, pyrazinyl, pyrimidinyl, pyrrolyl, pyrazolyl, imidazolyl, thiazolyl, oxazolyl, isooxazolyl, thiadiazolyl,oxadiazolyl, thiophenyl, furanyl, quinolinyl, isoquinolinyl, and the like.

It will be appreciated that the above groups and/or compounds, as described herein, may be optionally substituted with any number of substituents or functional moieties. That is, any of the above groups may be optionally substituted. As used herein, the term “substituted” is contemplated to include all permissible substituents of organic compounds, “permissible” being in the context of the chemical rules of valence known to those of ordinary skill in the art. In general, the term “substituted” whether preceded by the term “optionally” or not, and substituents contained in formulas of this invention, refer to the replacement of hydrogen radicals in a given structure with the radical of a specified substituent. When more than one position in any given structure may be substituted with more than one substituent selected from a specified group, the substituent may be either the same or different at every position. It will be understood that “substituted” also includes that the substitution results in a stable compound, e.g., which does not spontaneously undergo transformation such as by rearrangement, cyclization, elimination, etc. In some embodiments, “substituted” may generally refer to replacement of a hydrogen with a substituent as described herein. However, “substituted,” as used herein, does not encompass replacement and/or alteration of a key functional group by which a molecule is identified, e.g., such that the “substituted” functional group becomes, through substitution, a different functional group. For example, a “substituted phenyl group” must still comprise the phenyl moiety and cannot be modified by substitution, in this definition, to become, e.g., a pyridine ring. In a broad aspect, the permissible substituents include acyclic and cyclic, branched and unbranched, carbocyclic and heterocyclic, aromatic and nonaromatic substituents of organic compounds. Illustrative substituents include, for example, those described herein. The permissible substituents can be one or more and the same or different for appropriate organic compounds. For purposes of this invention, the heteroatoms such as nitrogen may have hydrogen substituents and/or any permissible substituents of organic compounds described herein which satisfy the valencies of the heteroatoms. Furthermore, this invention is not intended to be limited in any manner by the permissible substituents of organic compounds. Combinations of substituents and variables envisioned by this invention are preferably those that result in the formation of stable compounds useful for the formation of an imaging agent or an imaging agent precursor.

The term “stable,” as used herein, preferably refers to compounds which possess stability sufficient to allow manufacture and which maintain the integrity of the compound for a sufficient period of time to be detected and preferably for a sufficient period of time to be useful for the purposes detailed herein.

Examples of optional substituents include, but are not limited to, halogen, azide, alkyl, aralkyl, alkenyl, alkynyl, cycloalkyl, hydroxyl, alkoxyl, amino, nitro, sulfhydryl, imino, amido, phosphonate, phosphinate, carbonyl, carboxyl, silyl, ether, alkylthio, sulfonyl, sulfonamido, ketone, aldehyde, ester, heterocyclyl, aromatic or heteroaromatic moieties, —CF₃, —CN, aryl, aryloxy, perhaloalkoxy, aralkoxy, heteroaryl, heteroaryloxy, heteroarylalkyl, heteroaralkoxy, azido, amino, halide, alkylthio, oxo, acylalkyl, carboxy esters, carboxamido, acyloxy, aminoalkyl, alkylaminoaryl, alkylaryl, alkylaminoalkyl, alkoxyaryl, arylamino, aralkylamino, alkylsulfonyl, carboxamidoalkylaryl, carboxamidoaryl, hydroxyalkyl, haloalkyl, alkylaminoalkylcarboxy, aminocarboxamidoalkyl, cyano, alkoxyalkyl, perhaloalkyl, arylalkyloxyalkyl, and the like.

### EXAMPLES

These and other aspects of the present invention will be further appreciated upon consideration of the following Examples, which are intended to illustrate certain particular embodiments of the invention but are not intended to limit its scope, as defined by the claims.

### Example 1

The following non-limiting example describes a process for the selection of a suitable emulsion or microemulsion composition for asphaltene removal using microfluidic devices. This set of experiments allowed for first the observation of asphaltene deposition in a porous medium using a microfluidic device, and second the visualization of the wash-off of the asphaltenes using different emulsion or microemulsion compositions and their equivalent surfactant packages (e.g., essentially identical compositions without solvent).

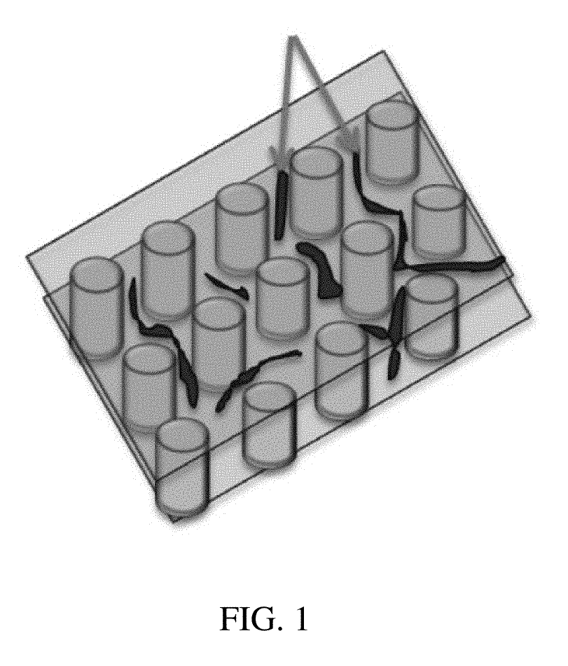

The microfluidic devices utilized in these experiments were glass and polymer devices in which fluid was made to flow through a model three-dimensional porous structure. The devices were made by etching or molding a pre-defined pattern of circular pillars and channels. FIG. 1 shows a schematic diagram showing asphaltene deposition on the surfaces of circular pillars in a microfluidic device, wherein the arrows indicate two representative asphaltene residues.

The depositions were formed by flowing asphaltenes dissolved in toluene into the microfluidic device along with a precipitant agent (e.g., heptane) in a 3:7 volume ratio using two different tubes connected by a T-junction. As the two fluids mixed with each other, asphaltenes precipitated and started to deposit on the pillar surfaces. Images of the deposition were captured using a microscope connected to a camera in order to magnify and illuminate the device. All of the experiments, unless otherwise stated, were run at room temperature.

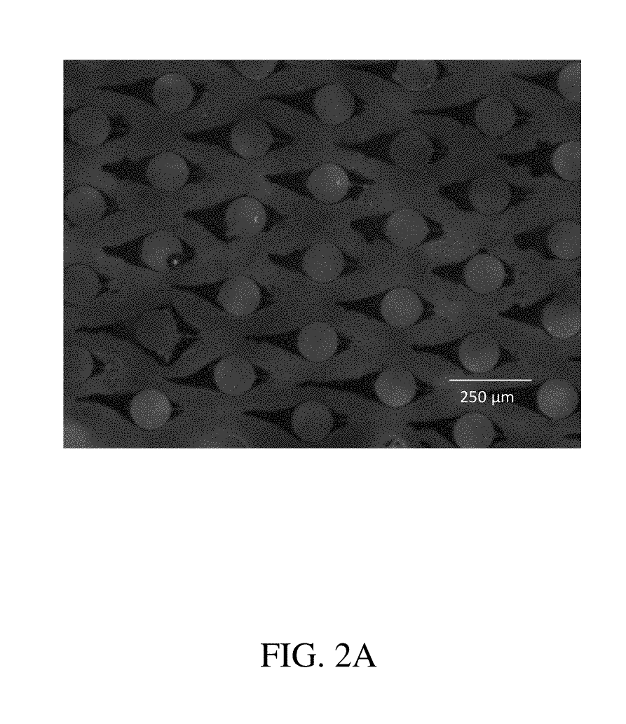

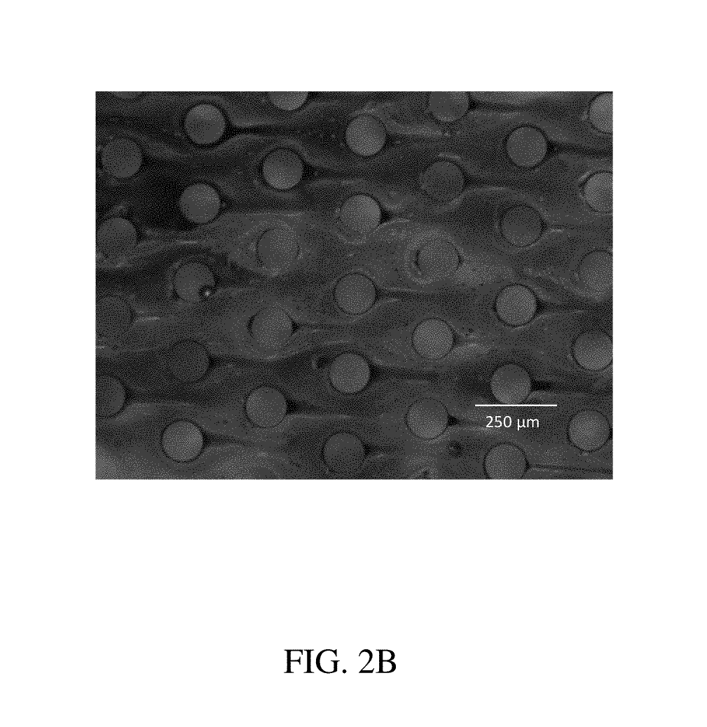

The microfluidic experiments allowed for a direct visualization of asphaltene removal using different emulsion or microemulsion compositions. In this example, the method was demonstrated for emulsions or microemulsions. FIG. 2A is a microscope image that shows the asphaltene deposition after 120 minutes of asphaltene-toluene-heptane flow through a microfluidic device at a rate of 60 microliters/min with an average pillar diameter of 125 microns. FIG. 2B is a microscope image that shows the same device after 120 minutes of flow at a rate of 60 microliters/min of 2 gallons per thousand (gpt) of 20 wt % benzyl benzoate and technical grade d-limonene at the indicated ratio, 22.5 wt % alcohol ethoxylate 25-7, 22.5 wt % isopropanol, and 35 wt % water, all diluted in 2 wt % KCl in water.

In order to quantify the amount of asphaltenes removed from the microfluidic devices, the images taken before (e.g., FIG. 2A) and after treatment (e.g., FIG. 2B) with different microemulsions comprising aromatic ester solvents were analyzed using image analysis software. For example, to quantify the amount of asphaltenes present, (e.g., the asphaltene coverage), the images were converted to grayscale, a threshold was set, and a calculation was made.

These microfluidics wash-off experiments were performed to determine the effect of the weight ratio of d-limonene to benzyl benzoate in a microemulsion comprising aromatic ester solvent benzyl benzoate on asphaltene wash-off performance. Microemulsions were made in which the solvent portion contained varying weight ratios of d-limonene to benzyl benzoate. These microemulsions were diluted to 2 gallons per thousand (gpt) in 2 wt % KCl in water for the wash-off experiments. To perform the testing, asphaltenes were precipitated into a microfluidic device using heptane, as described above. After the asphaltenes were deposited, the microemulsion dilution was made to flow through the device at a rate of 60 microliters/min and the device was monitored with a camera. The asphaltene coverage before treatment with a microemulsion comprising d-limonene and benzyl benzoate was compared to the asphaltene coverage after treatment. The amount of asphaltenes remaining was measured using image processing software in the same way described above.

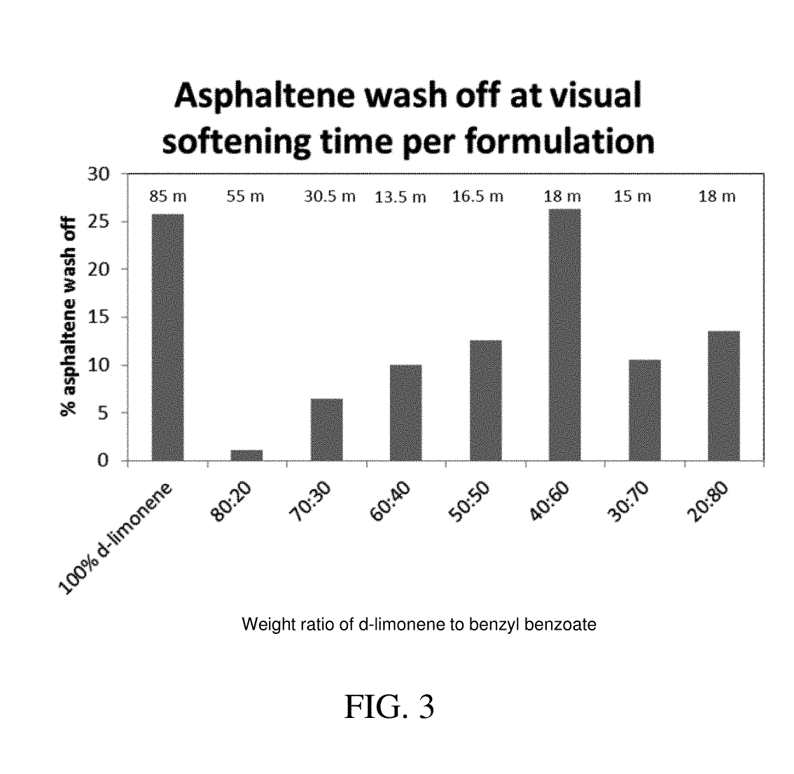

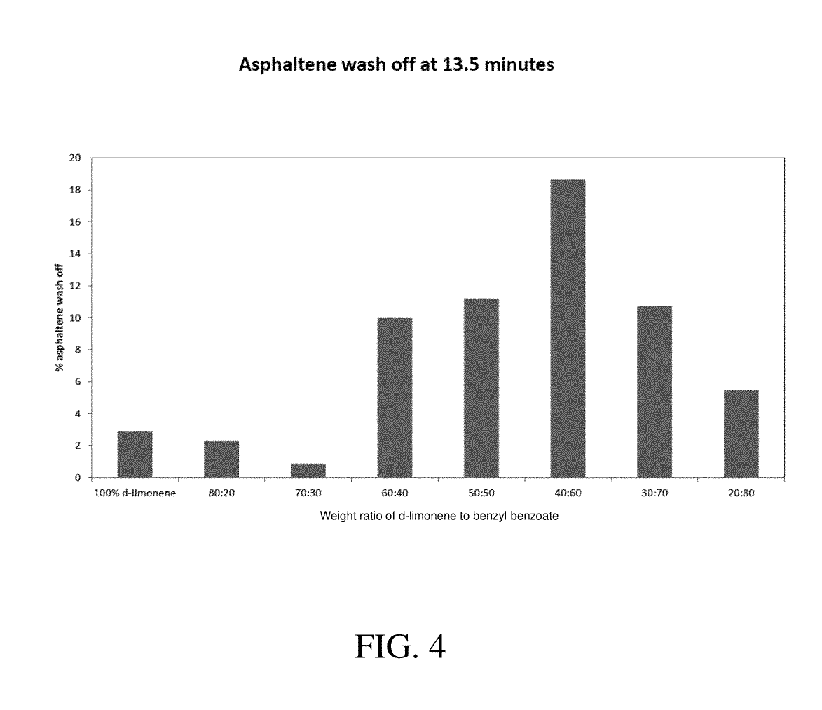

For the microemulsion formulations used in this set of experiments, as the asphaltenes were washed away, they began to form streaks, and in some cases chunks of the asphaltenes broke away and moved along the flow path. This process made it difficult to measure asphaltene quantities by image analysis. To work around this, the time when this softening and streaking began was noted, and measurements of the wash-off at that time were made. These results are shown in FIG. 3. The sample that softened the fastest was the one with a d-limonene:(benzyl benzoate) weight ratio of 60:40, with a softening time of 13.5 minutes. To obtain a comparison across samples, the asphaltene wash-off at this time was also measured for all samples, and these results are shown in FIG. 4. The general formulation in these examples included 20 wt % benzyl benzoate and technical grade d-limonene at the indicated ratio, 22.5 wt % alcohol ethoxylate 25-7, 22.5 wt % isopropanol, and 35 wt % water.

The microemulsions comprising solvent blends with weight ratios of d-limonene:(benzyl benzoate) ranging from 60:40 to 20:80 showed the best performance, as shown in FIG. 4. For systems in which the weight ratio of d-limonene:(benzyl benzoate) was less than 20:80, a microemulsion was no longer formed. At 13.5 minutes, these samples showed from 2 times to 6 times the wash-off of the d-limonene-only microemulsion formulation (FIG. 4). As shown in FIG. 3, the performance of the 40:60 formulation at 18 minutes was equivalent to the d-limonene-only formulation at 85 minutes, showing that wash-off was more than 4.5 times faster with the solvent blend.

This example demonstrated that the performance of microemulsion formulations within the range of d-limonene:(benzyl benzoate) weight ratios 60:40 to 20:80 showed performance improvement (See e.g., FIG. 4), and this effect was the strongest when the ratio of d-limonene:(benzyl benzoate) was 40:60.

### Example 2

The following non-limiting example describes the results of microfluidics wash-off experiments like those in Example 1 that were performed in the current example to determine the effect of a microemulsion comprising d-limonene and methyl salicylate on asphaltene wash-off performance. A microemulsion was made in which the solvent portion contained a weight ratio of d-limonene to methyl salicylate of 3:7. This microemulsion was diluted to 2 gallons per thousand (gpt) in 2% KCl by weight of water for the wash-off experiments. To perform the testing, asphaltenes were precipitated into a microfluidic device using heptane as described in Example 1.

The asphaltene coverage before treatment with a microemulsion comprising d-limonene and methyl salicylate was compared to the asphaltene coverage after treatment. Asphaltene wash-off performance of the microemulsion comprising d-limonene and methyl salicylate was compared to that of an equivalent microemulsion without methyl salicylate. The microemulsion containing d-limonene and methyl salicylate that was employed to accomplish the wash-off comprised by 6 wt % technical grade d-limonene, 14 wt % methyl salicylate, 22.5 wt % alcohol ethoxylate 25-7, 22.5 wt % isopropanol, and 35 wt % water. The amount of asphaltenes remaining was measured using image processing software as described in Example 1. The percent asphaltene wash-off at 120 minutes for this microemulsion composition was 48%. The microemulsion without methyl salicylate comprised by weight 20 wt % technical grade d-limonene, 22.5 wt % alcohol ethoxylate 25-7, 22.5 wt % isopropanol, and 35 wt % water. The percent asphaltene wash-off at 120 minutes for this microemulsion composition without methyl salicylate was 30%.

This example demonstrated that the performance of a microemulsion formulation with a weight ratio of d-limonene to methyl salicylate of 3:7 showed better asphaltene wash-off performance than a comparable formulation without methyl salicylate.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, e.g. elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, e.g. the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element or a list of elements. In general, the term “or” as used herein shall only be interpreted as indicating exclusive alternatives (e.g. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “between” in reference to a range of elements or a range of units should be understood to include the lower and upper range of the elements or the lower and upper range of the units, respectively. For example, the phrase describing a molecule having “between 6 to 12 carbon atoms” should mean a molecule that may have, e.g., from 6 carbon atoms to 12 carbon atoms, inclusively. For example, the phrase describing a composition comprising “between about 5 wt % and about 40 wt % surfactant” should mean the composition may have, e.g., from about 5 wt % to about 40 wt % surfactant, inclusively.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, e.g. to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A composition for treating an oil and/or gas well having a wellbore, comprising:
a microemulsion, wherein the microemulsion comprises
an aqueous phase;
a surfactant; and
a solvent blend, comprising a first type of solvent and a second type of solvent, having a weight ratio from about 3:2 to about 1:4,
wherein the first type of solvent is a terpene and the second type of solvent is an aromatic ester solvent.

2. The composition of claim 1, wherein the terpene is selected from the group consisting of d-limonene, dipentene, alpha terpineol, alpha pinene, beta pinene, and eucalyptol, or combinations thereof.

3. The composition of claim 1, wherein the aromatic ester solvent is selected from the group consisting of esters of salicylates, benzoates, cinnamates, and phthalates, or combinations thereof.

4. The composition of claim 1, wherein the solvent blend further comprises butyl 3-hydroxybutanoate.

5. The composition of claim 1, wherein the aromatic ester solvent is benzyl benzoate.

6. The composition of claim 1, wherein the aromatic ester solvent is methyl salicylate.

7. The composition of claim 1, wherein the microemulsion comprises from about 1 wt % to about 60 wt % of the aqueous phase versus the total weight of the composition.

8. The composition of claim 1, wherein the microemulsion comprises from about 1 wt % to about 30 wt % of the solvent blend versus the total weight of the composition.

9. The composition of claim 1, wherein the microemulsion comprises from about 5 wt % to about 40 wt % of the surfactant, versus the total weight of the composition.

10. The composition of claim 1, wherein the surfactant is a nonionic surfactant.

11. The composition of claim 10, wherein the nonionic surfactant is an ethoxylated alcohol.

12. The composition of claim 1, wherein the microemulsion further comprises a co-solvent that is an alcohol.

13. The composition of claim 12, wherein the alcohol comprises isopropanol.

14. The composition of claim 12, wherein the alcohol is from about 1 wt % to about 35 wt % versus the total weight of the composition.

15. The composition of claim 1, wherein the first type of solvent and the second type of solvent have a weight ratio from about 3:2 to about 3:7.

16. The composition of claim 1, wherein the first type of solvent and the second type of solvent have a weight ratio from about 9:11 to about 7:13.

17. The composition of claim 1, wherein the first type of solvent and the second type of solvent have a weight ratio of about 2:3.

18. A method of treating an oil and/or gas well having a wellbore, comprising:
delivering a composition into the wellbore, wherein the composition comprises a microemulsion, wherein the microemulsion comprises
an aqueous phase;
a surfactant; and
a solvent blend, comprising a first type of solvent and a second type of solvent, having a weight ratio from about 3:2 to about 1:4,
wherein the first type of solvent is a terpene and the second type of solvent is an aromatic ester solvent; and
reducing residues on or near the wellbore using the composition.

19. The method of claim 18, wherein the residues comprise kerogens, asphaltenes, paraffins, organic scale, or combinations thereof.

20. The method of claim 18, wherein the terpene is selected from the group consisting of d-limonene, dipentene, alpha terpineol, alpha pinene, beta pinene, and eucalyptol, or combinations thereof.

21-35. (canceled)
